(19) United States
(12) Patent Application Publication
(10) Pub. No.: US 2025/0335408 A1
(43) Pub. Date: Oct. 30, 2025

(54) SYSTEM MODIFICATION BASED ON CORRELATIONS BETWEEN OPERATIONAL DOMAIN PARAMETERS AND PERFORMANCE INDICATORS IN AUTONOMOUS SYSTEMS AND APPLICATIONS

(71) Applicant: NVIDIA Corporation, Santa Clara, CA (US)

(72) Inventors: Kenny Chowdhary, Hercules, CA (US); Jonas Nilsson, Los Gatos, CA (US); Michael Cox, Menlo Park, CA (US)

(21) Appl. No.: 18/649,851

(22) Filed: Apr. 29, 2024

(51) Int. Cl. G06F 16/22

(52) U.S. Cl. CPC G06F 16/2228

(57) ABSTRACT

Embodiments of the present disclosure may relate to a method of modifying system behavior based on one or more determined correlations. In some embodiments, the method may include obtaining first data and second data where the first data may include one or more performance indicator values that may correspond to the performance of the system and where the second data may include one or more operational domain parameters that may correspond to the system. In some embodiments, the method may additionally include assembling a data structure based on the first data and the second data. In some embodiments, the method may additionally include determining one or more correlations between individual operational domain parameters and individual performance indicator values based on the assembled data structure. In some embodiments, the method may additionally include modifying one or more aspects of the system based on the determined correlations.

### BACKGROUND

Systems, subsystems, machines, etc. are typically designed to perform under a broad set of circumstances. For example, autonomous and/or semi-autonomous systems (e.g., ego machines) are designed to perform operations on roads or other navigable surfaces (rural roads, city streets, highways, freeways, warehouse floors, etc.). Under these broad set of circumstances exist more particular circumstances and/or parameters under which a system may perform operations at any given time. Those parameters may be described as operational domain parameters (or operation design domain (ODD) parameters). Based on those operational domain parameters, systems may perform differently. In many instances, the capabilities of system performance are largely defined and/or determined based on the operational domain parameters at any given time under which the system may perform.

In order to modify system behavior to improve performance of the system based on the operational domain parameters, it may be helpful to determine which operational domain parameter(s) affect system performance and/or to what degree. In addition, it may be helpful to determine which portions of system performance may be affected by which operational domain parameters, which may present a correlational problem. This correlational problem is particularly difficult in instances where the systems are complex and the operational domain in which the systems are designed to operate include many different parameters. One purpose in determining correlations between performance and operational domain parameters may be to modify or adjust aspects of the system based on the domain parameters such that the system is able to perform in an improved manner in various circumstances.

One or more traditional approaches to determining correlations between system performance and operational design parameters include manually selecting and/or extracting data corresponding to system performance and corresponding data associated with the environment in which the system may be performing operations. Further, one or more comparisons may be made to the data to determine whether and to what extent the data may be correlated. However, manual comparisons are expensive, both in terms of overall cost and with respect to time. Often, there are hundreds or thousands of potential indicators corresponding to performance of the system and a corresponding number of operational design parameters. In many instances, time constrains the number of manual comparisons that may be performed thus limiting the correlations that may be determined between various performance indicators and operational design parameters. This limitation in the current methodology becomes increasingly problematic as systems increase in complexity and are designed to operate in domains of increasing variability.

### SUMMARY

According to one or more embodiments of the present disclosure, one or more systems, sub-systems, machine models, neural networks, etc. may be used to determine one or more correlations between individual operational domain parameters and one or more individual performance indicator (e.g., key performance indicator (KPI)) values. In some embodiments, in response to the one or more determined correlations, one or more aspects of the system may be modified.

Reference to “correlation” in the present disclosure may relate to how one element, factor, parameter, etc. may respond to or behaves in relation to another. In some instances, a precise mathematical definition of correlation may vary depending on various factors including, for example, context, type of data (e.g., categorical or numerical), etc. In some instances, correlation may imply causal relationships between one or more of the various elements, factors, parameters, inputs, outputs, etc. In some instances, identifying one or more correlations may provide directions of association (e.g., positive or negative) between multiple elements, factors, parameters, inputs, outputs, etc. that otherwise would be impossible or infeasible by manual inspection.

In some embodiments, to determine one or more respective correlations, first data and second data may be obtained. In some embodiments, the first data may include one or more performance indicator values that may correspond to the performance of the system. In some embodiments, the second data may include one or more operational domain parameters (or operational design domain (ODD) parameters) that may correspond to operation and performance of the system as indicated by the one or more performance indicator values. In some embodiments, the second data may be obtained from one or more sources and may be preprocessed to improve uniformity between the data obtained from the one or more sources.

In some embodiments, the method may further include assembling a data structure based on the first data and the second data. In some embodiments, assembling the data structure may include aligning the first data and the second data based on time. For example, in some embodiments, the aligning of the first data and the second data may include associating data subsets corresponding to the first data and data subsets corresponding to the second data, according to corresponding time frames.

Further, in some embodiments, one or more respective correlations may be determined between the individual operational domain parameters and one or more individual performance indicator values based on the assembled data structure. In some embodiments, one or more aspects of the system may be modified based on the determined correlations. Additionally or alternatively, the one or more correlations may be determined based on distributions between performance indicator values and operational domain parameters that may be time-aligned in the data structure.

In some embodiments, determining one or more correlations may additionally include determining a degree of confidence for at least one or more of the correlations. In some embodiments, determining a degree of confidence corresponding to correlations may indicate whether adequate data may have been collected to determine the correlations. In some embodiments, a low degree of confidence may result in a determination that any correlation associated with the low degree of confidence may be considered an unknown correlation. In some embodiments, in response to a determination that a correlation may be unknown, more data may be collected. Additionally or alternatively, a system may avoid circumstances in which the correlation between performance and operational domain parameters may be unknown. For example, in scenarios where the system may be performing one or more safety operations, the system may avoid any circumstances, parameters, environmental conditions etc. that may be associated with an unknown correlation.

Embodiments of the present disclosure may increase an ability of the system to perform one or more operations in a corresponding operational domain. For example, one or more aspects of a system may be modified or otherwise altered based on the one or more determined correlations. In some embodiments, the correlations may provide indications as to the degrees to which operational domain parameters may affect different performance indicators. For example, the different correlations may include scores associated therewith that indicate the strength of the correlations. In some embodiments, the correlations may be ranked according to the scores to help identify which operational domain parameters may be most associated with which performance indicators, or vice versa.

Additionally or alternatively, the correlations may be used to determine under which operational domain parameters the system may perform well or poorly. For example, the output data may be sorted according to performance indicator values (e.g., either from highest to lowest or vice versa) and also sorted to indicate which operational domain parameters are most correlated with the different performance indicator values.

In these and other embodiments, the correlations may be used to determine which operational domain parameters would benefit from further testing or operation to better determine performance of the system. For example, correlations having relatively low degrees of confidence may indicate that not enough data is present with respect to a particular operational domain parameter and/or a particular performance indicator. As such, further testing may be performed with respect to the particular operational domain parameter to obtain more data for the particular performance indicator.

### BRIEF DESCRIPTION OF THE DRAWINGS

The present systems and methods correspond to determining one or more correlations between operational domain parameters and system performance indicators, wherein:

FIG. 1 illustrates an example environment for generating an output using a correlation pipeline, in accordance with one or more embodiments of the present disclosure;

FIG. 2 illustrates an example environment for generating an operational domain/performance indicator output, in accordance with one or more embodiments of the present disclosure;

FIG. 3 illustrates an example environment for generating an output that may be sent to or otherwise communicated to a system, in accordance with one or more embodiments of the present disclosure;

FIG. 4A illustrates an example visualization showing various operational domain parameters and respective correlations between the operational domain parameters with a performance indicator, in accordance with one or more embodiments of the present disclosure;

FIG. 4B illustrates an example visualization showing a bivariate analysis of correlations between two individual operational domain categories and a performance indicator, in accordance with one or more embodiments of the present disclosure;

FIG. 5 is a flow diagram showing a method for modifying one or more aspects of a system based on one or more determined correlations between data corresponding to performance indicators and data corresponding to operational domain parameters, in accordance with one or more embodiments of the present disclosure;

FIG. 6A is an illustration of an example autonomous vehicle, in accordance with one or more embodiments of the present disclosure;

FIG. 6B is an example of camera locations and fields of view for the example autonomous vehicle of FIG. 6A, in accordance with one or more embodiments of the present disclosure;

FIG. 6C is a block diagram of an example system architecture for the example autonomous vehicle of FIG. 6A, in accordance with one or more embodiments of the present disclosure;

FIG. 6D is a system diagram for communication between cloud-based server(s) and the example autonomous vehicle of FIG. 6A, in accordance with one or more embodiments of the present disclosure;

FIG. 7 is a block diagram of an example computing device suitable for use in implementing one or more embodiments of the present disclosure; and

FIG. 8 is a block diagram of an example data center suitable for use in implementing one or more embodiments of the present disclosure.

### DETAILED DESCRIPTION

Systems, including systems and subsystems corresponding to a machine, may collect, generate, and/or otherwise obtain data corresponding to performance of the systems or of other systems or subsystems during operation. In some instances, the systems may accept little to no user input, such as, for example, autonomous or semi-autonomous systems. Additionally or alternatively, the systems may accept user input for performance of operations, such as, for example, manned vehicles, computers, handheld electronics, etc. Further, in some instances, systems may include systems and/or subsystems that may or may not be present in or otherwise function in connection with a machine. For example, some systems may include self-supervised machine learning systems, large language models (LLMs), visual language models (VLMs), other model types (e.g., climate models, population models, infection rate models to name a few), etc.

In some embodiments, to standardize and track performance of a system, one or more performance indicators—in some instances referred to as “key performance indicators (KPIs)”—may be determined, assigned, and/or tracked using the performance data corresponding to the system. In some instances, one or more performance indicators may include categories of performance and/or performance capabilities. Additionally or alternatively, in some embodiments, one or more performance indicators may include data corresponding to a score, where the score may represent system performance corresponding to a particular category. An individual system may have multiple performance indicators (e.g., on the order of tens, hundreds, thousands, etc.) associated therewith.

In some embodiments, performance indicators corresponding to particular systems may be determined in the context of the systems operating in an operational domain. In some embodiments, the operational domain may refer to certain features of interest corresponding to an environment. In some embodiments, the operational domain may include specific features or characteristics based at least on a purpose or a goal of a particular system. Additionally or alternatively, the operational domain may include scenarios of interest, where the scenarios may include real-world and/or hypothetical conditions that may be present in the real-world data. In some embodiments, the operational domain may describe and/or include features or characteristics of an environment in which a particular system may perform operations. For example, in the context of an autonomous vehicle performing operations, one or more of the operational domains corresponding to the autonomous vehicle may include features that may affect traveling of the autonomous vehicle, such as roads, lanes, lane lines, turning lanes, or obstacles (e.g., other vehicles, pedestrians, structures, etc.).

In some embodiments, the operational domain may include one or more categories, where the one or more categories may include respective parameters associated therewith. The one or more categories—e.g., described as operational domain categories—may include groups of parameters, such as, for example, technical parameters—e.g., computing resources, memory resources, operational platforms, processing power, sensor capabilities, etc. Additionally or alternatively, the one or more categories may include environmental parameters (e.g., weather, temperature, humidity, terrain types, etc.), geographical parameters (e.g., boundaries within which a system may operate), time of day or night, traffic conditions, speed, type of environment (e.g., rural, urban, suburban, etc.), and other parameters or conditions that may describe an environment in which the system may perform operations. In some embodiments, particular variables within an operational domain category may be described as an operational domain parameter.

In some embodiments, systems may include multiple subsystems whose performance may respectively affect performance indicators. Further, different operational domains may affect different subsystems differently such that scores associated with performance indicators may vary for the overall system and/or for individual subsystems depending on the operational domain categories and/or the operational domain parameters corresponding thereto. In addition, the number of subsystems and/or operational domain parameters that may affect individual performance indicators may be large. Each of the aforementioned considerations may be considered factors (e.g., multiple subsystems respectively affecting performance, different operational domains affecting performance, etc.). In some embodiments, each of the example factors may increase a difficulty in assessing which subsystems affect individual performance indicators (e.g., establishing whether one or more domain parameters may be correlated with system performance). Further, the different factors may also increase the difficulty in assessing effects of different operational domain parameters or joint effects of two or more operational domain parameters on different subsystems in the context of different performance indicators.

One or more embodiments of the present disclosure may relate to automatically determining correlations between performance indicators corresponding to a system and one or more operational domain parameters under which the system may perform. In some embodiments, one or more aspects of the system may be modified based on the determined correlations. In some embodiments, by determining correlation and/or causation between different operational domain parameters and performance indicators corresponding to the system, one or more operations may be altered to improve system performance. Additionally or alternatively, testing parameters, areas of focus for research and development, etc. may be improved based on the determined correlation between the performance indicators and the operational domain parameters.

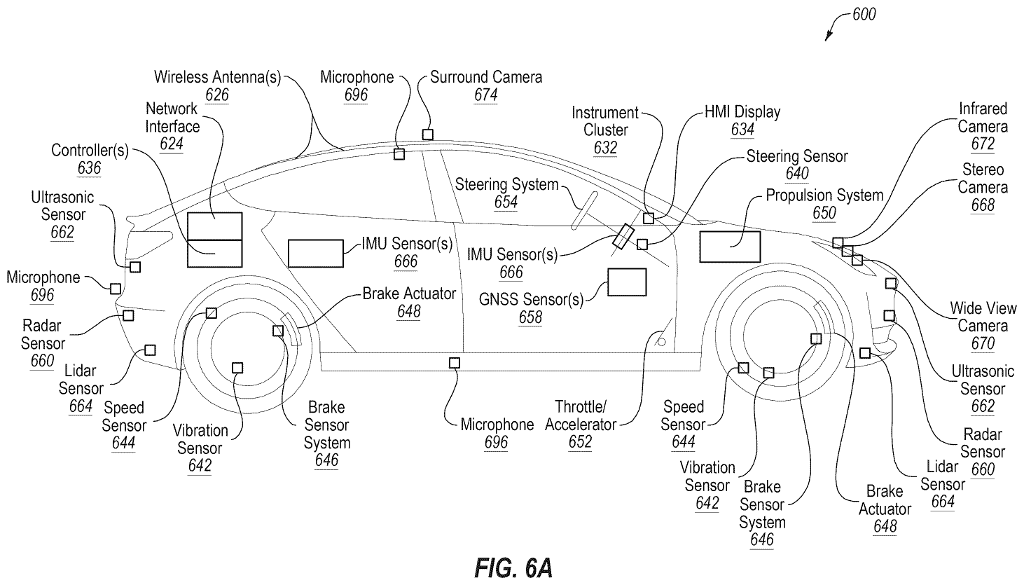

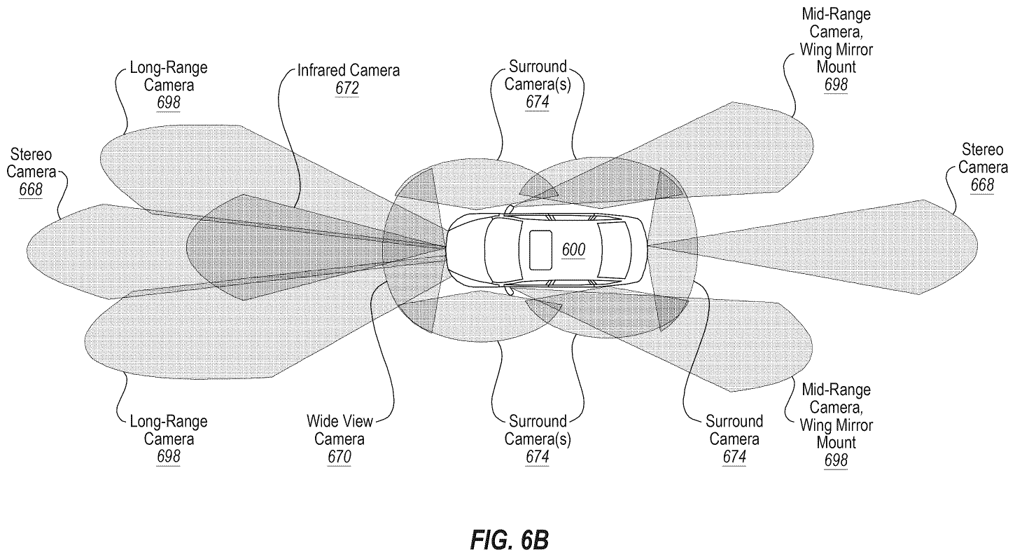

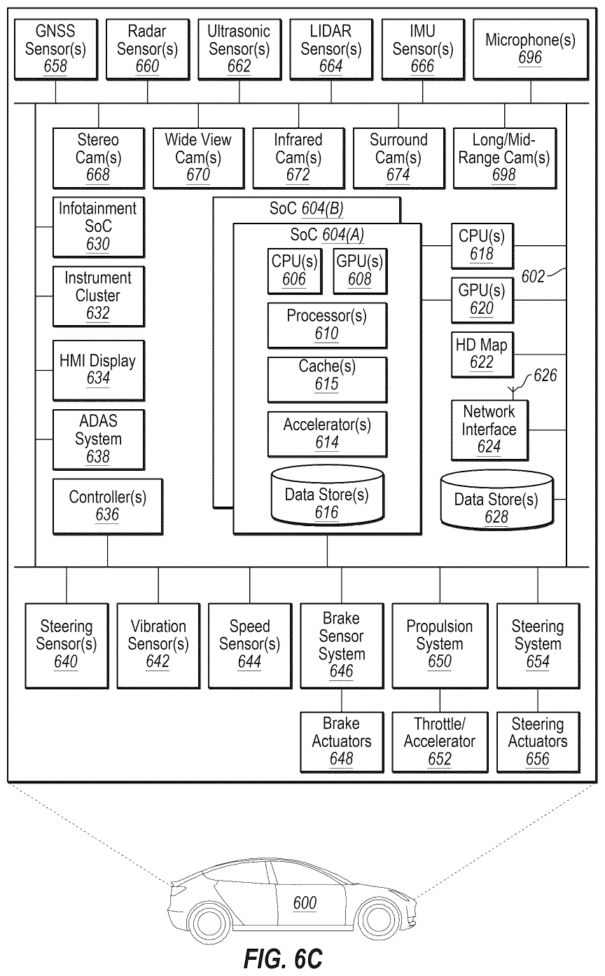

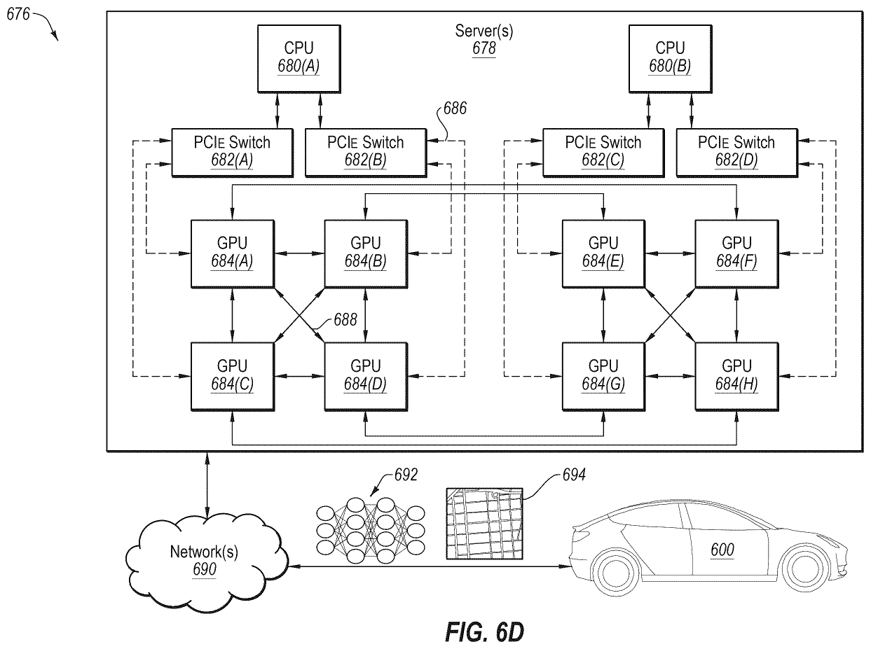

One or more of the embodiments disclosed herein may relate to performing one or more correlation determinations between performance indicators and operational domain parameters in the context of an ego-machine. Additionally or alternatively, one or more embodiments may include modifying one or more aspects, characteristics, behaviors, etc. corresponding to an ego-machine based on the determined correlation(s). In some embodiments, the ego-machine may include any applicable machine or system that is capable of performing one or more autonomous and/or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous or semi-autonomous vehicle or machine 600 (alternatively referred to herein as “vehicle 600” or “ego-machine 600) described with respect to FIGS. 6A-6D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems that implement one or more language models, such as one or more large language models (LLMs) that process textual, audio, image, sensor, and/or other data types to generate one or more outputs, systems that implement one or more visual language models (VLMs), systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

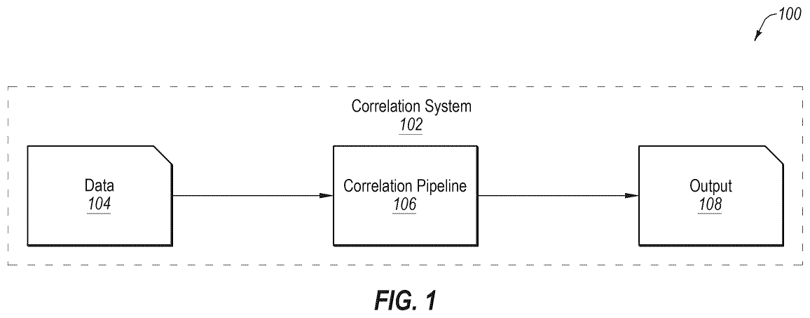

Now referring to FIG. 1, FIG. 1 illustrates an example environment 100 for generating an output 108 using a correlation pipeline 106, in accordance with one or more embodiments of the present disclosure. In some embodiments, the output 108 may include one or more determined correlations associated with data 104 that may be generated using a system, such as, for example, a correlation system 102 that may perform one or more operations using the data 104 to generate and/or otherwise determine the output 108.

The correlation system 102 may include one or more systems that may be configured to determine correlations between the data 104. In some embodiments, the correlation system 102 may be a standalone system that may receive the data 104 from one or more different sources and determine correlations based on the data 104. Additionally or alternatively, the correlation system 102 may be included in one or more other systems, such as, for example, the system and/or machine to which the data 104 may correspond. In some embodiments, the correlation system 102 may be configured to perform one or more comparisons based on the data 104. Additionally or alternatively, the correlation system 102 may be configured to direct one or more other systems to perform one or more comparison operations using the data 104 in order to generate the output 108.

In some embodiments, the data 104 may correspond to a particular system, subsystem, machine, device, etc. For example, the data 104 may correspond to a particular machine (e.g., a particular vehicle, drone, electronic device, communication device, gaming device, automation device, etc.). Additionally or alternatively, the data 104 may correspond to a particular subsystem. For example, in the context of autonomous vehicles, the data 104 may correspond to a perception subsystem, a localization subsystem, a diagnostic subsystem, a mapping subsystem, a communication subsystem, a control subsystem, etc. Additionally or alternatively, the data 104 may correspond to one or more portions of a subsystem, for example, within a perception subsystem, the data 104 may correspond to one or more machine learning models and/or deep neural networks associated with the perception subsystem.

In some embodiments, the data 104 may be generated using one or more sensors. In some embodiments, the data 104 may correspond to an environment in which the one or more sensors (e.g., temperature sensors, image sensors, speed sensors, accelerometers, RADAR sensors, LiDAR sensors, proximity sensors, pressure sensors, etc.) may be located. For example, a camera may generate image data that may be included in the data 104 where the image data may correspond to a portion of an environment at a particular time.

In some embodiments, the data 104 may have been previously collected. In some embodiments, the data 104 may include publicly available data corresponding to a particular environment. For example, publicly available temperature data, wind speed data, terrain data and the like. In some embodiments, similar to the data 104 that may have been collected and/or generated in real time or near real-time, the publicly available data may similarly be packaged, processed, used, transmitted, etc.

Additionally or alternatively, the data 104 may not have been generated using one or more sensors. For example, the data 104 may include map data corresponding to a map, and/or any other type of data generated, obtained, received, or otherwise used by the system performing the data communication. Continuing the example, one or more systems may be configured to retrieve and/or otherwise obtain the data 104 from one or more other systems, servers, web locations, etc.

In some embodiments, the data 104 may correspond to one or more operational domain parameters that may be associated with a particular system and/or machine. For example, the one or more operational domain parameters that may correspond to a particular system may include technical parameters that may correspond to the particular system such as, for example, computing resources, memory resources, operational platforms, processing power, sensor capabilities, etc. In some embodiments, the data 104 corresponding to the technical operational domain parameters may include metadata corresponding to particular sensors, data that may be defined by the particular system, etc.

In some embodiments, the one or more operational domain parameters may include environmental parameters (e.g., weather, temperature, humidity, terrain types, etc.). In some embodiments, the data 104 corresponding to the environmental parameters may include temperature data, humidity data, map data corresponding to a map that may identify data corresponding to an environment in which the particular system may be located. For example, in the context of an autonomous vehicle, the map data corresponding to a map may include data and/or information associating a location of the autonomous vehicle with a road type on which the autonomous vehicle may be operating. In some embodiments, the data 104 may include geographical parameters (e.g., boundaries within which a system may operate), time of day or night, traffic conditions, speed, type of environment (e.g., rural, urban, suburban, etc.), and other parameters or conditions that may describe an environment in which the system may perform operations.

In some embodiments, the data 104 may correspond to one or more performance indicators that may be associated with the particular system and/or machine. Additionally or alternatively, the data 104 may include scores associated with performance indicators, where the scores may represent how well the system may perform operations corresponding to the performance indicator at a given time. For example, in the context of a perception subsystem included in a machine that performs one or more autonomous or semi-autonomous operations, the perception subsystem may be assigned a performance indicator that may indicate an ability of the perception subsystem to perceive obstacles. For example, the ability of the perception system to perceive obstacles may be generated and/or determined by comparing the obstacles perceived by the perception system as compared with the obstacles encountered. Continuing the example, based on the comparison, a performance indicator score may be given and/or assigned to the perception subsystem. In some embodiments, the performance indicator score may indicate how well the perception subsystem may have perceived obstacles at a particular time or range of times. In some embodiments, the data 104 may include both the data associated with the performance indicator scores and the corresponding performance indicator scores. Additionally or alternatively, the data 104 may include data associated with the performance indicator scores that may be used to determine the performance indicator scores themselves.

In some embodiments, the data 104 may be transmitted or otherwise communicated to one or more systems, subsystems, etc. corresponding to the correlation system 102. In some embodiments, the systems and/or processes used to perform operations using the data 104 may include the correlation pipeline 106.

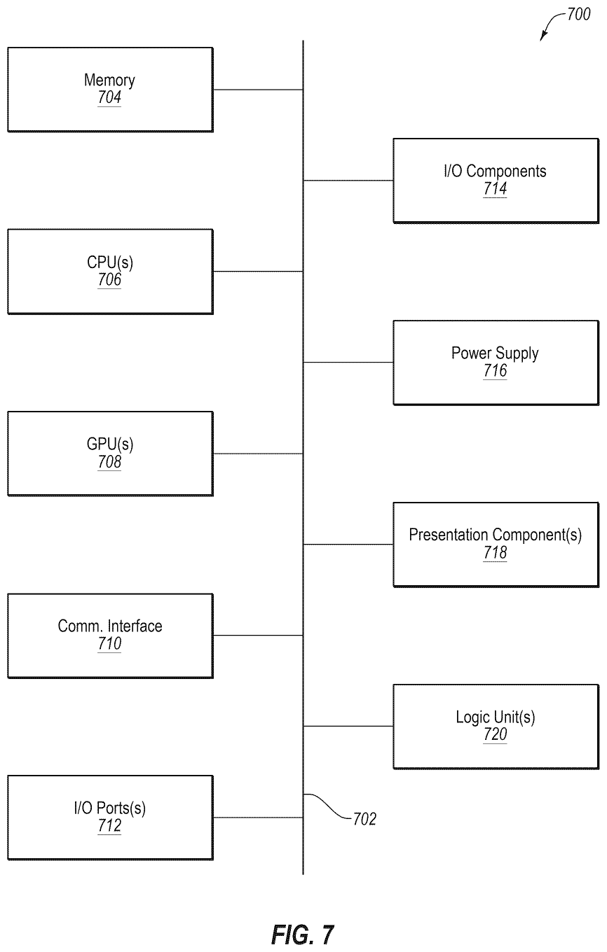

In some embodiments, the correlation pipeline 106 may include code and routines configured to allow a computing system to perform one or more operations. Additionally or alternatively, the correlation pipeline 106 may be implemented using hardware including one or more processors, CPUs, graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, the correlation pipeline 106 may be implemented using a combination of hardware and software. In the present disclosure, operations described as being performed by the correlation pipeline 106 may include operations that the correlation pipeline 106 may direct a corresponding computing system to perform. In these or other embodiments, the correlation pipeline 106 may be implemented by one or more computing devices, such as that described in further detail with respect to FIGS. 6A-6D, 7, and/or 8.

In some embodiments, the correlation pipeline 106 may be configured to generate one or more performance indicator scores (also referred to herein as “performance scores”) using the data 104 corresponding to one or more performance indicators. In some embodiments, performance indicator scores may be determined using any suitable technique. In some embodiments, the performance indicator scores may indicate performance of one or more aspects of a machine or system. In some embodiments, the performance indicator score(s) may indicate the performance of the system as compared with a theoretical ideal. For example, in the context of determining fuel consumption performance of an autonomous vehicle, a theoretical ideal value (e.g., miles per gallon of gasoline) may be determined. Continuing the example, the actual performance of the fuel consumption of the autonomous vehicle may be compared to the theoretical ideal to determine a score representing the performance of the autonomous vehicle. In some embodiments, the performance indicator score may include the actual performance of the machine or system without comparison to one or more other theoretical or actual values. For example, again in the context of tracking performance of fuel consumption for autonomous vehicles, the performance indicator score may include the miles travelled per gallon and/or liter of gasoline consumed.

In some embodiments, one or more performance parameters, factors, variables, etc. corresponding to the system may be provided to one or more machine learning models, deep learning models, large language models, etc. In some embodiments, the one or more models may be configured to determine one or more performance indicator scores based on the provided performance parameters, factors, variables, etc. For example, in some embodiments, various performance parameters may be provided to an artificial intelligence (AI) system (e.g., machine learning model, neural network, large language model, etc.) that may be trained to determine system performance scores or indicators based at least on such performance parameters.

In some embodiments, the performance scores may be determined for a particular time and/or a particular time period. In some embodiments, a performance indicator score may be determined based on data 104 that may correspond to an individual time stamp. For example, in the context of determining performance of a perception subsystem that may correspond to an autonomous vehicle, the performance may be determined based on an individual encounter with an object or pedestrian that may or may not have been perceived. Continuing the example, the encounter may be determined based on a presence or absence of an object or pedestrian during a particular time frame (e.g., 1 second, 5 second, 10 seconds, etc.). Further continuing the example, the performance indicator score may correspond to performance of the perception subsystem (e.g., encounters perceived vs. total encounters) during a particular time or range of times (e.g., 1 second, 10 minutes, 10 hours, etc.).

In some embodiments, the performance indicator scores may reflect a number or distribution of failures that may correspond to the system at a particular time. In some embodiments, a failure may be defined a priori based on the system and/or the performance corresponding to the system that may be measured. In some embodiments, a failure associated with performance may be defined based on one or more external requirements (e.g., safety requirements, performance specifications, system limitations, etc.). In some embodiments, a distribution of failures may serve as an indication or a reference point from which one or more performance indicator scores may be determined. In some embodiments, a greater number of failures corresponding to a particular performance metric may result in a lower performance indicator score. Correspondingly, in some embodiments, a lower number of failures associated with a particular performance metric may result in a comparatively higher performance indicator score.

Additionally or alternatively, the correlation pipeline 106 may be configured to receive one or more performance indicator scores that may be included in the data 104. In some embodiments, the correlation pipeline 106 may not perform any determinations that result in generating or otherwise determining performance indicator scores; rather, in some embodiments, the correlation pipeline 106 may receive the already determined performance indicator scores from one or more other sources, systems, machines, etc.

In some embodiments, the correlation pipeline 106 may be configured to generate one or more data structures that may include portions of the data 104 that may correspond to performance indicators and/or performance indicator scores. For example, a first table may be generated that may include one or more performance indicator scores for a particular system at one or more time stamps. In some embodiments, the data structure may include each of the individual performance indicator scores that may correspond to a particular system or subsystem over a particular period of time. In some embodiments, the performance indicator scores may be organized in the data structure by time.

Additionally or alternatively, the correlation pipeline 106 may be configured to generate one or more data structures that may include portions of the data 104 that may correspond to one or more operational domain parameters. For example, a second table may be generated that includes indications of different operational domain parameters that may correspond to the particular system (e.g., to the system itself or an environment in which the system is operating) at points in time that correspond to those included in the first table.

In some embodiments, the correlation pipeline 106 may be configured to generate one or more combined data structures that may be based on the first table and the second table. For example, in some embodiments, the first table may include first time stamps that respectively correspond to times for the different performance indicator scores. Additionally or alternatively, the second table may include second time stamps that respectively correspond to times at which the different operational domain parameters may be present. In these and other embodiments, the correlation pipeline 106 may time-align data included in the first table and the second table based on the corresponding first timestamps and the second timestamps.

For example, in some embodiments, the first timestamps and the second timestamps may be used to determine which operational domain parameter values were present at the times that correspond to certain performance indicator scores. In these and other embodiments, the operational domain parameter values and performance indicator scores that correspond to same time frames may be grouped together or otherwise associated with each other in the combined data structure such that the performance indicator scores of the first table and the operational domain parameters of the second table may be merged or aligned according to time.

In some embodiments, the correlation pipeline 106 may be configured to perform one or more operations using the combined data structure to determine correlations between the performance indicator scores and the operational domain parameters. For example, in some embodiments, categorical measures of association may be determined based on operational domain parameters and performance indicator scores that are time aligned (e.g., that correspond to same time frames and are accordingly associated with each other). In some embodiments, categorical measures of association may include variables with a finite set of possible values, such as road type, as opposed to continuous variables that can take on an infinite set of possible values (e.g., speed).

In some embodiments, a distribution of performance indicator values (e.g., performance indicator scores that fall into particular ranges) for the different operational domain parameters may be determined based on time-aligned performance indicator scores and operational domain parameters. For example, a distribution of performance failures (as indicated by certain performance score values) for different operational domain parameters may be determined. In these and other embodiments, the distributions may be determined by constructing a contingency table or similar data structure. In some embodiments, the contingency table may be configured to show and/or illustrate a respective failure rate for one or more corresponding categories. In some embodiments, the contingency table may show univariate or bivariate histograms of the distribution of failure rates over different operational domain parameters.

In these and other embodiments, correlations and/or associations may be determined based on the distributions. For example, in some embodiments, a chi-squared or Cramer's V test may be used with respect to the distributions to compute the correlations or associations between certain categorical operational domain parameters and performance indicator scores. Other possible techniques include building machine-learned predictive models, e.g., linear regression, random forests, or neural networks, that may be configured to map operational domain parameters to key performance indicators, which may be used to obtain a measure or ranking of importance among the operational domain parameters.

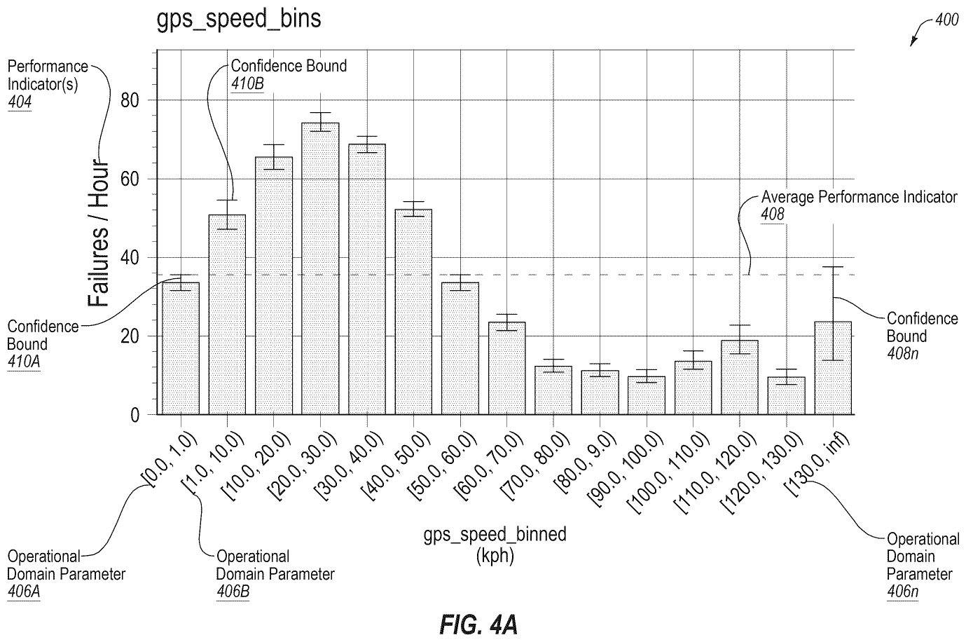

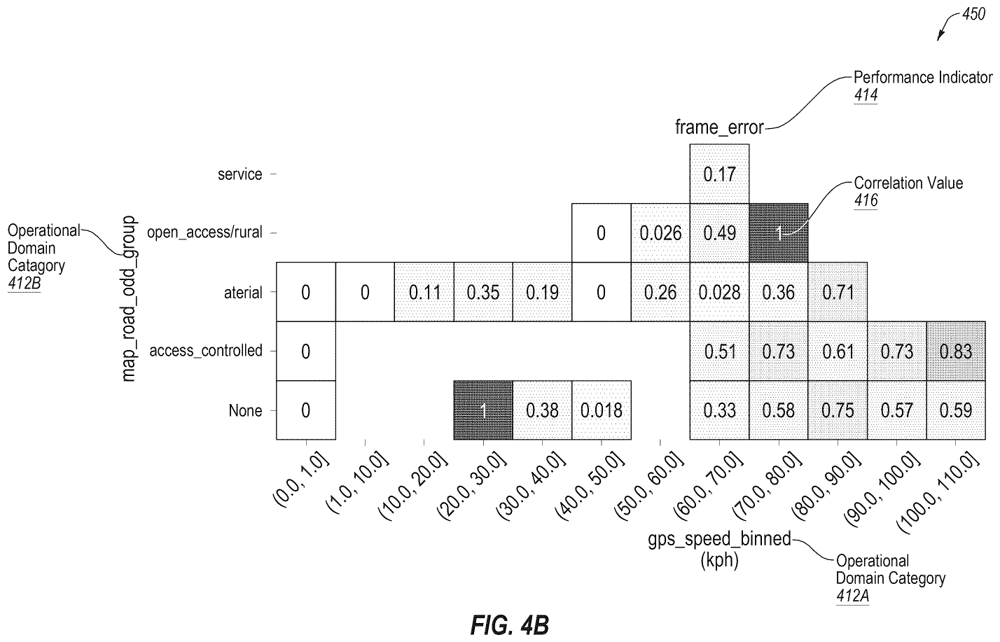

In some embodiments, a confidence bound may be determined for the determined correlations. For example, the confidence bound may include a score or a value that indicates a margin of error with respect to individual correlation determinations. In some embodiments, the more data 104 that may correspond to a particular performance indicator and/or operational domain parameter, the lower the range of values included in the confidence bound. Correspondingly, less data 104 corresponding to particular performance indicators and/or operational domain parameters, may result in a larger range of values that may be included in the degree of confidence. An example degree of confidence may be illustrated and/or described in further detail in the present disclosure, such as, for example, with respect to FIG. 4A.

In some embodiments, the correlation pipeline 106 may be configured to generate the output 108. In some embodiments, the output 108 may include one or more of the correlations that may have been determined using the correlation pipeline 106. Additionally or alternatively, the output 108 may include each of the correlations that may have been determined using the correlation pipeline 106. In some embodiments, the output 108 may include confidence values corresponding to the determined correlations. Additionally or alternatively, the output 108 may include one or more visualizations corresponding to the determined correlations between the data 104 corresponding to the operational domain parameters and the data 104 corresponding to the performance indicators.

In some embodiments, the correlation pipeline 106 may be configured to generate the output 108 based on data 104 that may correspond to a discrete time period. For example, in the context of an autonomous vehicle performing one or more tasks (e.g., travelling from a first location to a second location), the correlation module 106 may be configured to determine one or more correlations between one or more respective operational domain parameters and one or more performance indicators based on the data 104 collected during the duration of the travelling from point A to point B. Continuing the example, the correlation module 106 may be configured to aggregate the data 104 corresponding to one or more other trips associated with the autonomous vehicle. In some embodiments, the correlation module 104 may be configured to aggregate all of the data 104 associated with the autonomous vehicle to determine the one or more correlations between respective operational domain parameters and performance indicators.

In some embodiments, the correlation module 106 may be configured to determine the one or more respective correlations based on the data 104 that may have been previously obtained. For example, in the context of an ego-machine, the correlation pipeline 106 may be a part of a computing system that may not be included in the ego-machine. Continuing the example, the correlation pipeline 106 may be configured to generate and/or determine respective correlations on past data 104. Additionally or alternatively, the correlation pipeline 106 may be configured to generate one or more correlations in real time or near real time. For example, continuing in the context of the ego-machine, the correlation pipeline 106 may be included in the ego-machine and may be configured to perform one or more operations on the data 104 that may be generated, collected, and/or otherwise obtained in real time or near real time. Continuing the example, the correlation pipeline 106 may be configured to update performance indicators, operational domain parameters, and respective correlations as the data 104 is received. Continuing the example, the ego-machine may be configured to use one or more other servers or computing resources external to the ego-machine to perform correlation determinations in real time or near real time. For example, the ego machine may be configured to communicate the data 104 to one or more edge servers or other processing systems that may be configured to perform the one or more correlation determinations.

Modifications, additions, or omissions may be made to FIG. 1 without departing from the scope of the present disclosure. For example, the amount of data 104, the number of systems, subsystems, processes, etc. that may be associated with the correlation pipeline 106, the amount and/or type of the output 108, etc. may vary. The specifics given and discussed are to help provide explanation and understanding of concepts of the present disclosure and are not meant to be limiting.

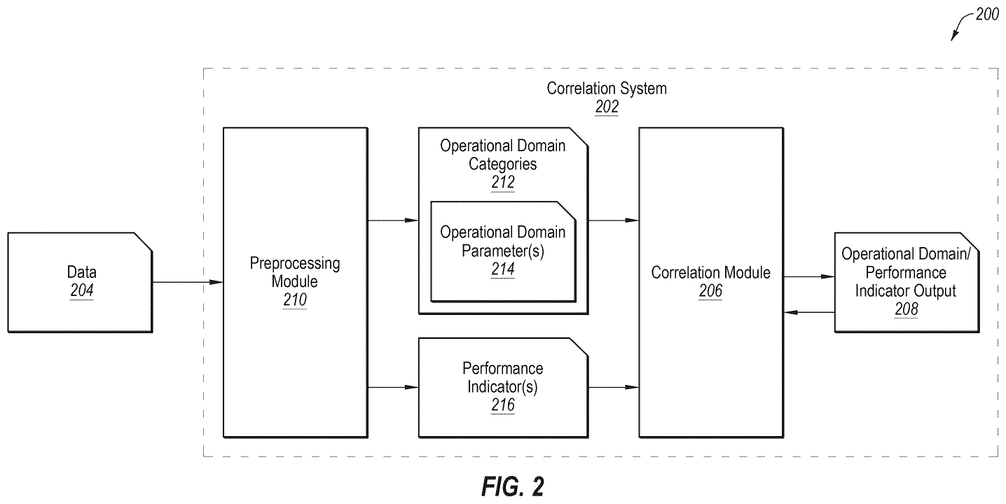

FIG. 2 illustrates an example environment 200 for generating an output 208, in accordance with one or more embodiments of the present disclosure. In some embodiments, the environment 200 may be the same as and/or an example implementation of the environment 100 as described further in the present disclosure, such as, for example, with respect to FIG. 1. In some embodiments, the environment 200 may include a correlation system 202 that may be configured to perform one or more operations using the data 204 to generate the output 208.

The data 204 may correspond to one or more operational domain parameters (e.g., operational domain parameters 214) and/or performance indicators (e.g., performance indicators 216). In some embodiments, the data 204 may correspond to operational domain parameters 214 and/or performance indicators 216 that may be associated with a particular system and/or machine. In these or other embodiments, the data 204 may be the same as and/or analogous to the data 104 that may be described and/or illustrated further in the present disclosure, such as, for example, with respect to FIG. 1. In some embodiments, the data 204 may be transmitted to and/or received by the correlation system 202. Additionally or alternatively, the data 204 may be generated and/or collected using the correlation system 202 and/or one or more systems, subsystems, machines, etc. that may be directed to collect, generate, or otherwise obtain the data 204 using the correlation system 202.

In some embodiments, the correlation system 202 may include one or more systems and/or subsystems that may be configured to perform one or more operations on the data 204. In some embodiments, the correlation system 202 may be the same as and/or an example of the correlation system 102 described and/or illustrated further in the present disclosure, such as, for example, in FIG. 1.

In some embodiments, the correlation system 202 may be configured to perform one or more operations on the data 204 to generate the output 208. In some embodiments, the correlation system 202 may include one or more modules, systems, subsystems, etc. that may be configured to perform operations on the data 204. In some embodiments, the correlation system 202 may include a preprocessing module 210 and/or a correlation module 206.

In some embodiments, the preprocessing module 210 and/or the correlation module 206 may include code and routines configured to allow a computing system to perform one or more operations. Additionally or alternatively, the preprocessing module 210 and/or the correlation module 206 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, the preprocessing module 210 and/or the correlation module 206 may be implemented using a combination of hardware and software. In the present disclosure, operations described as being performed by the preprocessing module 210 and/or the correlation module 206 may include operations that the respective modules individually or in combination may direct a corresponding computing system to perform. In these or other embodiments, the modules may be implemented by one or more computing devices, such as that described in further detail with respect to FIGS. 6A-6D, 7, and/or 8.

In some embodiments, the preprocessing module 210 may be configured to perform one or more operations on the data 204. In some embodiments, the preprocessing module 210 may be configured to differentiate between different subsets of the data 204. For example, the data 204 may be obtained from several different sources. Continuing the example, the preprocessing module 210 may be configured to separate and/or differentiate between the data 204 corresponding to different sources. For example, the preprocessing module 210 may be configured to perform operations based on whether the data 204 may be obtained from one or more sensors as compared with the data 204 that may be obtained from one or more web sources, systems, machines, etc.

In some embodiments, the preprocessing module 210 may be configured to separate and/or differentiate the data 204 based, at least in part, on the metadata accompanying the data 204. In some embodiments, the preprocessing module 210 may be configured to determine whether the data 204 may be included in a same category of data 204 based on one or more markers, characteristics, metadata, etc. that may correspond to the data 204. For example, the data 204 may be associated with different sensors. Continuing the example, the preprocessing module 210 may be configured to organize the data 204 based on which sensor may have generated and/or collected the data 204—e.g., based on associated metadata, matching sampling rates, data structures, characteristics associated with one or more data streams, etc.

In some embodiments, the preprocessing module 210 may be configured to differentiate between the data 204 that may correspond to one or more performance indicators associated with a particular system and the data 204 that may correspond to one or more operational domain parameters associated with the particular system. In some embodiments, the preprocessing module 210 may categorize the data 204 based on whether the data 204 may correspond to an operational domain parameter 214 or a performance indicator 216. In some embodiments, the preprocessing module 210 may be configured to categorize the data 204 based on one or more labels, data formats, metadata, sampling rates, units corresponding to the data 204, etc. Additionally or alternatively, the data 204 may be pre-labeled as either corresponding to a performance indicator 216 or an operational domain parameter 214 and, in those embodiments, the preprocessing module 210 may be configured to separate and organize the data 204 into one or more data structures accordingly.

In some embodiments, the preprocessing module 210 may be configured to perform and/or direct one or more operations to label the data 204—e.g., via text classification, image annotation, land cover classification, label segmentation, etc. Additionally or alternatively, the data 204 may be labeled prior to being obtained by the preprocessing module 210. In some embodiments, the preprocessing system 210 may be configured to compare the data 204 with labeled data 204.

In some embodiments, the preprocessing module 210 may be configured to perform one or more operations on the data 204 to improve uniformity between the data 204 that may be obtained from different sources. In some embodiments, different data 204 may be sampled at different sampling frequencies, for example. As a result, the data 204 that may be obtained from different sources may correspond to a same time window but may be sampled at different frequencies and/or rates such that comparison between different portions of the data 204 may be difficult. For example, sensors collecting and/or generating speed data corresponding to an ego-machine may generate, collect, and/or otherwise obtain data 204 at a different rate than sensors measuring temperature or wind speed. In response, the preprocessing module 210 may be configured to resample one or more streams of data 204. In some embodiments, resampling various portions or streams of the data 204 may decrease noise from the data 204. Further, in some embodiments, resampling portions of the data 204 may increase an ability to compare various streams of the data 204.

In some embodiments, resampling the data 204 may include performing one or more interpolation operations that may result in, for example, up-sampling the data 204. In some embodiments, the preprocessing module 210 may be configured to add one or more data points to the data 204 using one or more interpolation determinations in order to standardize and/or increase uniformity within the data 204. For example, the interpolation determinations may include linear interpolation, polynomial interpolation, spline interpolation, nearest-neighbor interpolation, bilinear interpolation, inverse distance weighting (IDW) interpolation, to name a few.

In some embodiments, resampling the data 204 may include down sampling the data 204. In some embodiments, down sampling the data 204 may include decreasing the number of data points corresponding to a particular portion of the data 204. In some embodiments, one or more down sampling techniques may include aggregating portions of the data 204, where aggregating the data 204 may include one or more of an average, a sum, a maximum, a minimum, etc. corresponding to a time interval. For example, the data 204 may include wind speed data that may be sampled every second. Continuing the example, the wind speed may need to be compared on a per-minute basis with one or more other portions of the data 204 rather than on a per-second basis. Further continuing the example, the wind speed data may be averaged over every minute such that the portion of the data 204 corresponding to the wind speed may include the wind speed measured on a per-minute basis.

In some embodiments, the pre-processing module 210 may be configured to reduce or eliminate duplicates included in the data 204, smooth averages of the data 204, reduce an amount of data 204, augment the data 204, scale the data 204 to a standard range (e.g., normalization and/or standardization operations), etc. In some embodiments, the pre-processing module 210 may be configured to categorize the data 204 into different data categories. In some embodiments, the pre-processing module 210 may be configured to categorize the data 204 as either corresponding to one or more operational domain categories 212 and/or operational domain parameter(s) 214 or one or more performance indicator(s) 216.

In some embodiments, the operational domain categories 212 may refer to a category or grouping of the data 204 that may correspond to a particular aspect of an operational domain that may correspond to a system. For example, in the context of an autonomous vehicle operating in a particular environment, a portion of the operational domain may include vehicle speed, the vehicle speed may include different ranges at different times, and those different ranges may be included in the operational domain category: vehicle speed.

As an example, the operational domain categories 212 may include groupings of technical resources, for example, computing resources, memory resources, operational platforms, processing power, sensor capabilities, etc. As an additional example, the operational domain categories 212 may include groupings of environmental variables that may include, for example, weather, temperature, humidity, terrain types, etc. Additionally or alternatively, the operational domain categories 212 may include groupings of geographical variables or parameters that may include, for example, boundaries within which a system may operate.

In some embodiments, particular variables within an operational domain category 212 may include an operational domain parameter 214. In some embodiments, the one or more operational domain parameters 214 may include one or more variables that may indicate a domain or a set of circumstances in which a system may be operating at a particular time. In some embodiments, the one or more operational domain parameters 214 may change based on the system, an environment where the system may be performing operations, respective times in which the system may be performing the operations, etc.

For example, in the context of an autonomous vehicle, an operational domain category 212 may include vehicle speed. Continuing the example, particular vehicle speeds and/or ranges of vehicle speed (e.g., 1-10 mph) may be one or more respective operational domain parameters 214 corresponding to the operational design category 212 “vehicle speed.” As an additional example, in the context of an autonomous vehicle, an operational domain category 212 may include road type. Continuing the example, particular road types may be considered operational domain parameters 214, respectively (e.g., residential road(s), service road(s), highway(s), freeway(s), city street(s), etc.). Further, as an additional example, in the context of computers and/or processing systems, an operational domain category 212 may include processing power. Continuing the example, particular amounts of processing power and/or ranges of processing power may be considered operational domain parameters 214, respectively (e.g., 2.0-3.5 GHz, 3.5-4.5 GHz, 4.5-5.5 GHz, etc.). In some embodiments, the one or more operational domain parameters 214 may be the same as and/or analogous to operational domain parameters that may be described further in the present disclosure, such as, for example, with respect to FIG. 1.

In some embodiments, the operational domain parameters 214 may be stored in one or more data structures that may correspond to a particular operational domain category 212. For example, a first table may be generated that may correspond to a particular operational domain category 212. Continuing the example, the first table may include data 204 that may correspond to one or more operational domain parameters 214 that may be included in the operational domain category 212. In some embodiments, multiple tables and/or data structures may be generated based on the one or more respective operational domain categories 212. In some embodiments, a table or other data structure may be generated for each operational domain category 212 where the table or other data structure may include data 204 associated with operational domain parameters 214 that may correspond to respective operational domain categories 212.

The performance indicators 216 may include data (e.g., data 204) that may indicate system performance. In some embodiments, the performance indicators 216 may include the underlying data corresponding to a determination of one or more performance indicator scores that may indicate a level of performance corresponding to a system, subsystem, machine, model, etc. Additionally or alternatively, the performance indicators 216 may include one or more performance indicator scores that may indicate performance of the system, subsystem, machine, model, etc. In some embodiments, several performance indicators 216 may correspond to a particular system.

For example, in the context of an ego-machine, one performance indicator 216 may indicate performance or a level of performance associated with perceiving obstacles, pedestrians, etc. Continuing the example, performance associated with perception may include multiple performance indicators 216—e.g., perception corresponding to RADAR data, image data, LiDAR data, etc. As an additional example, again in the context of an ego-machine, a performance indicator 216 may indicate a level of performance corresponding to path prediction corresponding to the ego-machine. In some embodiments, one or more of the performance indicators 216 may be compared with one or more of the operational domain parameters 214. In some embodiments, each of the performance indicators 216 corresponding to the system may be compared with each of the operational domain parameters 214 to determine one or more correlations between the operational domain parameters 214 and the performance indicator(s) 216.

In some embodiments, the performance indicators 216 may be the same as and/or analogous to performance indicators and/or performance indicator scores that may be described and/or illustrated further in the present disclosure, such as, for example, with respect to FIG. 1.

In some embodiments, the performance indicators 216 may be organized in one or more data structures. In some embodiments, the performance indicators 216 may be organized within the one or more data structures according to time. For example, performance indicators 216 corresponding to a system, subsystem, etc. may be different and/or include different data 204 based on a time or range of times corresponding to which performance may be measured. In some embodiments, the performance indicators 216 may be organized in a data structure separate and apart from the one or more data structures that may correspond to the operational domain categories 212 and/or the operational domain parameters 214. Additionally or alternatively, the performance indicators 216 may be organized in one or more of the same data structures as one or more of the operational domain categories 212 and/or the operational domain parameters 214.

In some embodiments, the one or more operational domain categories 212, the one or more operational domain parameters, and/or the one or more performance indicators 216 may be provided, transmitted, or otherwise communicated to the correlation module 206.

In some embodiments, the correlation module 206 may be configured to perform one or more operations on the operational domain categories 212, the operational domain parameters 214, and/or the performance indicators 216. In some embodiments, the correlation module 206 may be configured to determine one or more correlations between the operational domain parameters 214 and the performance indicators 216. In some embodiments, the correlation module 206 may be configured to time align the operational domain parameters 214 and the performance indicators 216 to compare the operational domain parameters 214 at one or more time stamps and/or time frames that may be the same as the time stamps and/or time frames at which the performance indicator 216 may have been determined.

In some embodiments, the correlation module 206 may be configured to determine one or more correlations between performance indicators 216 and singular operational domain parameters 214. Additionally or alternatively, the correlation module 206 may be configured to perform, for example, bivariate statistical analyses to determine correlations between performance indicators 216 and multiple operational domain parameters 214. In some embodiments, one or more data structures, e.g., a contingency table, may be generated wherein the data 204 corresponding to multiple operational domain parameters 214 and/or performance indicators 216 may be stored and/or compared. In some embodiments, one or more statistical operations may be performed to determine correlations between multiple variables (e.g., multiple domain operation parameters 214). In some embodiments, based on the type of data corresponding to the operational domain parameters, one or more statistical analyses may assist in determining one or more correlations—e.g., one or more of a phi-coefficient analysis, Cramer's V analysis, contingency coefficient analysis, among others may be used to determine the one or more correlations between multiple operational domain parameters 214 and/or performance indicators 216.

For example, in the context of an ego-machine corresponding to the correlation module 206, the correlation module 206 may be configured to time-align vehicle speed—a first operational domain category 212 including multiple operational domain parameters 214—and air temperature—a second operational domain category 212 including multiple operational domain parameters 214. Further continuing the example, the correlation module 206 may be configured to time-align data 204 corresponding to performance indicators 216 associated with the system. In some embodiments, by time-aligning the data 204 corresponding to the vehicle speed, the air temperature, and the performance indicators 216, one or more correlations may be determined based on multiple parameters corresponding to the system.

In some embodiments, the correlation module 206 may be the same as and/or included in the correlation pipeline 106 that may be described and/or illustrated further in the present disclosure, such as, for example, with respect to FIG. 1. In some embodiments, the correlation module 206 may be configured to generate the output 208 that may correspond to the determined correlations.

In some embodiments, the output 208 may include one or more correlations between performance indicators 216 and one or more operational domain parameters 214. In some embodiments, the output 208 may include each of the determined correlations corresponding to the performance indicators 216 and operational domain parameters 214. In some embodiments, the output 208 may include a magnitude corresponding to the correlations, where the magnitude may indicate a strength of a determined correlation between one or more operational domain parameters 214 and a performance indicator 216.

In some embodiments, the output 208 may include a listing or other structure that may include the strongest correlations between performance indicators 216 and operational domain parameters 214. For example, the operational domain parameter/performance indicator output 208 may include a list of five or ten correlations between operational domain parameters 214 and performance indicators 216 corresponding to a particular system. For example, the strongest correlations may be determined using one or more statistical analyses (e.g., a chi-squared statistical analysis).

For example, in the context of an ego-machine that includes a perception subsystem, the performance indicator 216 may include pedestrian detection and the operational domain category 212 may include time of day where the corresponding operational domain parameters 214 may include particular times or time ranges while driving. Continuing the example, the correlation module 206 may determine that time ranges around dusk (e.g., 4:00 pm or 5:00 pm) and at dawn (e.g., 5:00 am, 6:00 am) have the strongest correlation to changes in performance indicator 216 (e.g., the highest impact on a performance indicator score associated with pedestrian detection). Further continuing the example, the correlation module 206 may identify the particular times or time ranges that may have the greatest impact on the performance indicators 216.

In some embodiments, the correlation module 206 may be configured to determine one or more correlations between the performance indicators 216 and one or more operational domain categories 212 using one or more statistical analyses (e.g., chi-squared, Cramer's V, etc.). In some embodiments, by determining one or more correlations between performance indicators 216 and operational domain categories 212, operational domain categories 212 may be compared to determine operational domain categories 212 that may be more strongly correlated to changes in performance indicators 216 than one or more other operational domain categories 212.

In some embodiments, the output 208 may be recirculated to the correlation module 206 for further analysis. In some embodiments, the correlation module 206 may be configured to perform one or more analyses based on failure rates corresponding to performance indicators 216, strong correlations between performance indicators 216 and operational domain parameters 214, etc.

In some embodiments, the output 208 may include a listing of operational domain categories 212 that may affect performance indicators 216 more than one or more other operational domain categories 212. In some embodiments, the correlation module 206 may then be configured to determine which operational domain parameters 214 associated with the operational domain categories 212 may more strongly correlate with the performance indicators 216.

In some embodiments, the operational domain/performance indicator outputs 208 may include one or more visualizations that may correspond to correlations between operational domain parameters 214 and performance indicators 216. In these or other embodiments, the operational domain/performance indicator outputs 208 may be the same as and/or analogous to the output 108 that may be described and/or illustrated further in the present disclosure, such as, for example, with respect to FIG. 1.

Modifications, additions, or omissions may be made to FIG. 2 without departing from the scope of the present disclosure. For example, the number of ego-machines 208, the number of sensors that may generate and/or collect the sensor data 202 may vary, the number of visibility confidence models 206 may vary. Further, the visibility system 204 may include multiple machine learning models, neural networks, perception systems, subsystems, etc. Additionally or alternatively, the visibility system 204 may be included in one or more other systems and/or machines other than the ego-machine 208. The specifics given and discussed are to help provide explanation and understanding of concepts of the present disclosure and are not meant to be limiting.

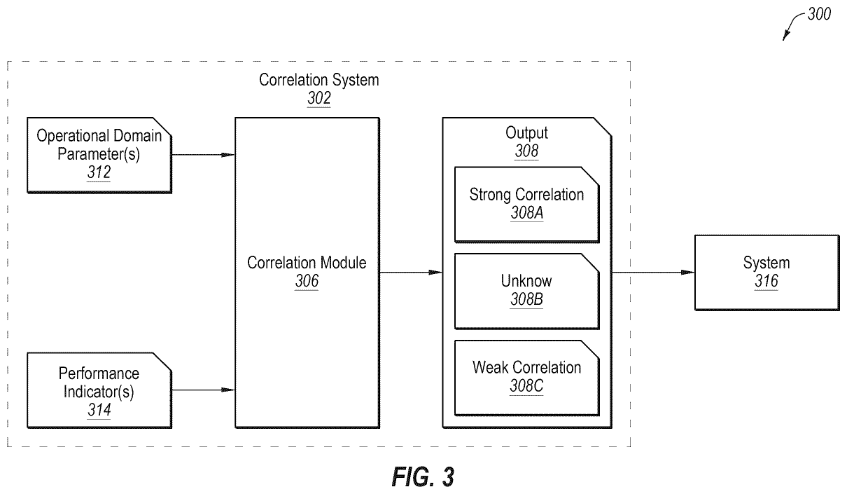

FIG. 3 illustrates an example environment 300 for generating an output 308 that may be communicated to a system 316, in accordance with one or more embodiments of the present disclosure. In some embodiments, the environment 300 may be an example of and/or analogous to the environment 200 and/or the environment 100 that may be described and/or illustrated further in the present disclosure, such as, for example, with respect to FIGS. 1 and/or 2. In some embodiments, the environment 300 may include a correlation system 302 that may be configured to perform one or more operations to generate the output 308.

The correlation system 302 may include one or more systems, subsystems, processes, models, etc. that may be configured to perform one or more operations. In some embodiments, the correlation system 302 may be included in one or more systems—e.g., the system 316. Additionally or alternatively, the correlation system 302 may be included in one or more other systems. In some embodiments, the correlation system 302 may include a standalone system that may be configured to generate the output 308. In these or other embodiments, the correlation system 302 may be the same as and/or analogous to the correlation system 102 and/or the correlation system 202 that may be described and/or illustrated further in the present disclosure, such as, for example, with respect to FIGS. 1 and/or 2. In some embodiments, the correlation system 302 may include a correlation module 306 that may be configured to perform one or more operations using operational domain parameters 312 and performance indicators 314 to generate the output 308.

In some embodiments, the operational domain parameters 312 may be the same as, analogous to, and/or an example of the operational domain categories 212 and/or the operational domain parameters 214 that may be described and/or illustrated further in the present disclosure, such as, for example, with respect to FIG. 2. In some embodiments, the performance indicators 314 may be the same as, analogous to, and/or an example of performance indicators 216 that may be described and/or illustrated further in the present disclosure, such as, for example, with respect to FIGS. 1 and/or 2.

In some embodiments, the correlation module 306 may include code and routines configured to allow a computing system to perform one or more operations. Additionally or alternatively, the correlation module 306 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, the correlation module 306 may be implemented using a combination of hardware and software. In the present disclosure, operations described as being performed by the correlation module 306 may include operations that the respective modules individually or in combination may direct a corresponding computing system to perform. In these or other embodiments, the modules may be implemented by one or more computing devices, such as that described in further detail with respect to FIGS. 6A-6D, 7, and/or 8. In some embodiments, the correlation module 306 may be the same as and/or analogous to the correlation pipeline 106 and/or the correlation module 206 that may be described and/or illustrated further in the present disclosure, such as, for example, with respect to FIGS. 1 and/or 2.

In some embodiments, the correlation module 306 may be configured to determine one or more correlations between the operational domain parameters 312 and/or the performance indicators 314. In some embodiments, the correlation module 306 may be configured to determine whether and to what extent the determined correlations may be strong, weak, or unknown, which is represented in FIG. 3 as a strong correlation 308A, an unknown correlation 308B, and a weak correlation 308C, respectively.

In some embodiments, the correlation module 306 may be configured to determine relative strength or weakness of determined correlations based on an average performance indicator score, failure rate, or other average indication of system performance associated with an operational domain category. In some embodiments, an average indicator of performance may be determined using data associated with the performance indicators 314. For example, performance indicator scores, failure rates, and/or other performance indicators 314 may be averaged over an operational domain category. In some embodiments, individual determined correlations between one or more operational domain parameters 312 and performance indicators 314 may be compared to the average indicator of performance (e.g., performance indicator scores, failure rates, etc.).

In some embodiments, the correlation module 306 may be configured to determine a confidence bound and/or confidence interval that may correspond to data associated with performance indicators 314. In some embodiments, the confidence interval/bound may be determined using one or more statistical analyses where the confidence interval may indicate a lower bound and upper bound within which the performance indicator 314 may lie. For example, in the context of an ego-machine, a performance indicator may include a failure rate per hour where the corresponding data may indicate that the system may fail 50 times per hour at a particular vehicle speed. Continuing the example, the data corresponding to the failure rate may indicate that the failure rate is likely, up to some certainty (e.g., 95% certainty), to fall between 40 failures per hour and 60 failures per hour. In some embodiments, a confidence bound or interval that exceeds a predetermined threshold may indicate that any determined correlation between the operational domain parameter 314 and the performance indicator 312 may be an unknown correlation 308B. In some embodiments, the correlation module 306, in response to determining an unknown correlation 308B, may be configured to flag or otherwise indicate that the determined correlation may need more data to properly determine whether the correlation is a strong correlation 308A or a weak correlation 308C.

In some embodiments, the representation of strong correlation 308A, unknown correlation 308B, and weak correlation 308C may represent a spectrum of relative correlation strength between performance indicators 314 and operational domain parameters 312. For example, each determined correlation may be designated as stronger or weaker than one or more other determined correlations (e.g., represented by various values, labels, colors, etc.). Continuing the example, the farther a performance indicator is from the average corresponding to an operational domain parameter 312, the stronger the correlation between the operational domain parameter 312 and the performance indicator 314. By contrast, the closer the performance indicator is to the average, the weaker the correlation between the operational domain parameter 312 and the performance indicator 314. In some embodiments, the correlation module 306 may be configured to perform similar analyses with multiple operational domain parameters using one or more bivariate analyses.

In some embodiments, the output 308 including the strong correlations 308A, the unknown correlations 308B, and/or the weak correlations 308C may include one or more visualizations that may illustrate correlations between operational domain parameters and performance indicators. In some embodiments, one or more visualizations may be generated for individual operational domain categories that may include various operational domain parameters 314 that may be correlated with one or more performance indicators 314. In these or other embodiments, example visualizations may be described and/or illustrated further in the present disclosure, such as, for example, with respect to FIGS. 4A and 4B.

In some embodiments, the output 308 that may include one or more strong correlations 308A, unknown correlations 308B, and/or weak correlations 308C may be sent or otherwise communicated to the system 316. In some embodiments, the system 316 may correspond to the operational domain parameters 312 and/or the performance indicators 314. For example, in the context of the performance indicators 314 indicating performance of an ego-machine, the system 316 may be the ego-machine.

In some embodiments, the system 316 may be configured to modify one or more aspects based on the output 308. In some embodiments, the system 316 may be configured to adjust one or more operations based on the determined correlations that may be included in the output 308. For example, the output 308 may include a strong correlation 308A between poor perception system performance based on image data at particular times during the day (e.g., at dawn, at dusk, at night, etc.). Continuing the example, the system 316 may adjust reliance on perception systems relying on image data during the time periods where there may be a strong correlation between particular time periods and poor performance. Further continuing the example, the system 316 may instead rely on RADAR data or LiDAR data to perform one or more perception operations during those times during the day or night.

In some embodiments, the system 316 may be configured to perform one or more operations to collect more data in scenarios where unknown correlations may be present. For example, it may be determined that a correlation between perception system performance and vehicle speeds of over 65 miles per hour is unknown due to a lack of data. Continuing the example, as a result, the system 316 may be configured to collect more data at vehicle speeds exceeding 65 mph to decrease the associated confidence bound or interval under the predetermined threshold. Additionally or alternatively, the system 316 may be configured to avoid scenarios where unknown correlations 308B may be present.

In some embodiments, the system 316 may be updated as more data is collected and as a greater number of correlations may be determined—as strong correlations 308A, unknown correlations 308B, or weak correlations 308C.

Modifications, additions, or omissions may be made to FIG. 3 without departing from the scope of the present disclosure. For example, the amount of correlation systems 302, the number of operational domain parameters 312, performance indicators 314, correlation modules 306, and/or systems 316 may vary. Additionally or alternatively, the number and relative strength of correlations between the operational domain parameters 312 and the performance indicators 314 may vary. The specifics given and discussed are to help provide explanation and understanding of concepts of the present disclosure and are not meant to be limiting.

FIG. 4A illustrates an example visualization 400 showing various operational domain parameters and respective correlations between the operational domain parameters with a performance indicator, in accordance with one or more embodiments of the present disclosure. In some embodiments, the visualization 400 may be an example of an output (e.g., the output 108, the output 208, and/or the output 308) described and/or illustrated further in the present disclosure, such as, for example, with respect to FIGS. 1, 2, and/or 3.

In some embodiments, the visualization may illustrate a bar graph showing relationships between operational domain parameters 406 and performance indicators 404. As shown in FIG. 4A, the operational domain parameters 406 may be included in an operational domain category “vehicle speed” which, in this instance, may be measured in kilometers per hour. In some embodiments, the operational domain category may include a first operational domain parameter 406A that may represent a speed range of 0-1 kph, a second operational domain parameter 406B that may represent a speed range of 1-10 kph, up to and including an nth operational domain parameter 406n which may represent speeds exceeding 130 kph.

FIG. 4A illustrates performance indicators 404 on the y-axis. As shown in FIG. 4A, the performance indicators 404 may include a number of failures per hour. For example, the failures per hour may indicate a number of instances where a perception system corresponding to the vehicle may have encountered an obstacle but did not detect the obstacle. As shown in FIG. 4A, the performance indicators 404 may be measured based on data corresponding to individual operational domain parameters 406. For example, there may be a different number of failures per hour corresponding to the first operational domain parameter 406A, the second operational domain parameter 406B, up to and including the nth operational domain parameter 406n.

As shown in FIG. 4A, an average performance indicator 408 (e.g., in this instance, an average failure rate) may be determined for the system. The average performance indicator 408 may be represented by a dotted horizontal line segment. In some embodiments, individual performance indicators 404 may be compared with the average performance indicator 408 to determine whether a correlation exists and to determine a relative strength of the correlation between the operational domain parameter 406 and the performance indicator 404.

In some embodiments, and as shown in FIG. 4A, one or more confidence bounds may be determined based on data corresponding to the performance indicators 404 that may be associated with individual operational domain parameters 406. For example, confidence bound 410A may visually represent the confidence bound corresponding to the performance indicator 404 associated with the first operational domain parameter 406A, confidence bound 410B may visually represent the confidence bound corresponding to the performance indicator 404 associated with the second operational domain parameter 406B, up to and including confidence bound 410n that may visually represent the confidence bound corresponding to the performance indicator 404 associated with the nth operational domain parameter 406n.

In some embodiments, and as shown in FIG. 4A, the confidence bound 408n may indicate that the performance indicator is not certain enough to determine whether a correlation between the performance indicator 404 and the nth operational domain parameter 406n may be strong or weak. As a result, the visualization 400 shows an unknown correlation between the nth operational domain parameter and the performance indicator 404.

Modifications, additions, or omissions may be made to FIG. 4A without departing from the scope of the present disclosure. For example, the number of operational domain parameter 406, the performance indicator(s) 404, the system corresponding to the visualization, the data corresponding to the visualization 400 may vary. Additionally or alternatively, the layout of the visualization may change, the visualization 400 is meant as an example of one embodiment displaying data corresponding to the correlations between operational domain parameters 406 and performance indicators 404. The specifics given and discussed are to help provide explanation and understanding of concepts of the present disclosure and are not meant to be limiting.

FIG. 4B illustrates an example visualization 450 showing a bivariate analysis of correlations between two individual operational domain categories 412 and a performance indicator 414, in accordance with one or more embodiments of the present disclosure. In some embodiments, the visualization 450 may be an example of an output (e.g., the output 108, the output 208, and/or the output 308) described and/or illustrated further in the present disclosure, such as, for example, with respect to FIGS. 1, 2, and/or 3.

In some embodiments, the visualization 450 may illustrate a contingency table showing relationships between operational domain categories 412 and performance indicators 414. As shown in FIG. 4A, the operational domain categories 412 may include a first operational domain category 412A that may indicate “vehicle speed” and a second operational domain category 412B that may indicate “road type.” In some embodiments, and as shown in FIG. 4B, the first operational domain category 412A may include one or more operational domain parameters; in this instance, individual ranges of vehicle speed in kilometers per hour. In some embodiments, and as shown in FIG. 4B, the second operational domain category 412B may include one or more operational domain parameters that may indicate different road types (e.g., service roads, arterial roads, rural roads, etc.).

FIG. 4B illustrates a performance indicator 414 that may indicate failures corresponding to path prediction. In some embodiments, the failures may be determined based on a difference between a predicted path and an actual path taken by a corresponding system. In some embodiments, and as shown in FIG. 4B, one or more correlation values 416 that may indicate a correlation strength between the overlapping operational domain parameters corresponding respectively to the first correlation domain category 412A and the second correlation domain category 412B and the performance indicator 414. A shown in FIG. 4B, as the strength of the correlation increases, the correlation value 416 approaches 1 and the weaker the correlation, the correlation value 416 approaches 0. In some embodiments, the strongest correlations may be provided to the system to modify one or more aspects of the system in response to the strong correlations. For example, in FIG. 4B, a vehicle speed of 70-80 kph with an open access/rural road type may correspond to a correlation value 416 of 1 which may indicate a strong correlation between the operational domain parameters and the performance indicator 414.

Modifications, additions, or omissions may be made to FIG. 4B without departing from the scope of the present disclosure. For example, the number of operational domain parameters 412A and/or 412B, the performance indicator(s) 414, the system corresponding to the visualization 450, the data corresponding to the visualization 450 may vary. Additionally or alternatively, the layout of the visualization 450 may change, the visualization 450 is meant as an example of one embodiment displaying data corresponding to the correlations between operational domain parameters 412 and performance indicators 414. The specifics given and discussed are to help provide explanation and understanding of concepts of the present disclosure and are not meant to be limiting.

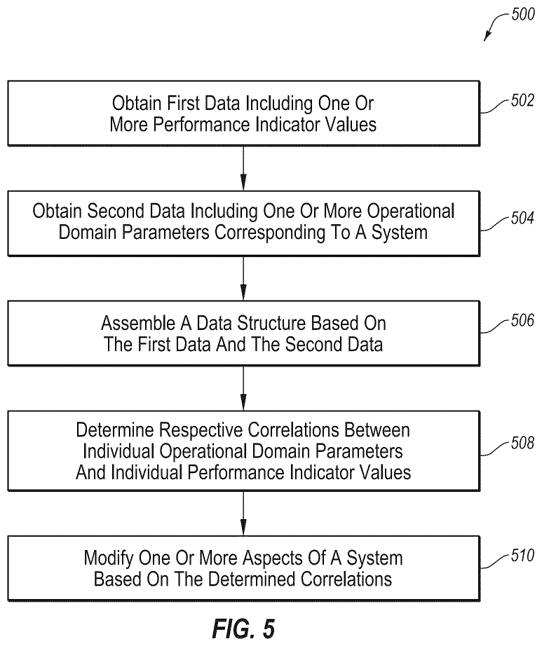

FIG. 5 is a flow diagram showing a method 500 for modifying one or more aspects of a system based on one or more determined correlations between data corresponding to performance indicators and data corresponding to operational domain parameters, in accordance with one or more embodiments of the present disclosure. The method 500 may include one or more blocks 502, 504, 506, 508, and 510. Although illustrated with discrete blocks, the operations associated with one or more of the blocks of the method 500 may be divided into additional blocks, combined into fewer blocks, or eliminated, depending on the particular implementation.

In some embodiments, the method 500 may include block 502. At block 502, first data may be obtained where the first data may include one or more performance indicator values. In some embodiments, the performance indicator values may correspond to performance of a particular system. In some embodiments, the first data may include a number of corresponding timestamps where the number of corresponding timestamps may correspond to the one or more performance indicator values. In some embodiments, the first data may be included in the data 104, the data 204, and/or data corresponding to one or more performance indicator(s) 314 that may be described and/or illustrated further in the present disclosure, such as, for example, with respect to FIGS. 1, 2, and 3.

At block 504, the method may additionally include obtaining second data where the second data may include one or more operational domain parameters that may correspond to the particular system. In some embodiments, the second data may be obtained from one or more sources. In some embodiments, the second data may be preprocessed using one or more preprocessing operations that may improve uniformity between the second data corresponding to the one or more sources. In some embodiments, the second data may include a second number of timestamps that may respectively correspond to the one or more operational domain parameters. In some embodiments, the first data may be included in the data 104, the data 204, and/or data corresponding to one or more operational domain parameters 312 that may be described and/or illustrated further in the present disclosure, such as, for example, with respect to FIGS. 1, 2, and 3.

At block 506, the method may additionally include assembling a data structure that may be based on the first data and the second data. In some embodiments, assembling the data structure may include aligning, according to time, the first data and the second data. In some embodiments, aligning the first data and the second data may include associating one or more subsets of the first data and one or more subsets of the second data that may correspond to same time frames. In some embodiments, aligning the first data and the second data may be based on the first number of timestamps and the second number of timestamps. In some embodiments, one or more systems and/or modules may be configured to assemble the data structure such as, for example, the correlation system 102, the correlation system 202, the correlation system 302, the correlation pipeline 106, the correlation module 206 and/or the correlation module 306 that may be described and/or illustrated further in the present disclosure, such as, for example, with respect to FIGS. 1, 2, and/or 3.

At block 508, the method may additionally include determining one or more respective correlations between individual operational domain parameters and individual performance indicator values. In some embodiments, the respective correlations may be determined based on the assembled data structure. In some embodiments, determining one or more correlations may be based on distributions between performance indicator values and operational domain parameters that may be time aligned in the data structure. In some embodiments, determining the one or more correlations may include determining at least one degree of confidence for at least one or the one or more correlations. In some embodiments, one or more systems and/or modules may be configured to determine the correlations such as, for example, the correlation system 102, the correlation system 202, the correlation system 302, the correlation pipeline 106, the correlation module 206 and/or the correlation module 306 that may be described and/or illustrated further in the present disclosure, such as, for example, with respect to FIGS. 1, 2, and/or 3.

At block 510, the method may additionally include modifying one or more aspects of the system based at least on the one or more respective correlations. For example, one or more aspects of the system may be automatically modified based on the results. In some embodiments, additional drives for data collection, additional requests for simulated data, and/or other request may be automatically generated in order to generate data that may be used to account for or solve for the issues that caused the correlations. For example, the additional data may be used to update or retrain one or more machine learning models or neural networks. In other examples, the outputs for the correlations may be used to update pre- or post-processing algorithms to better account for the operational domain parameters that are correlated with certain performance issues. For example, where path predictions are consistently off with some relation to wind speeds/direction, this information may be factored into the system to adjust the path outputs based on measured wind speeds/directions.

Modifications, additions, or omissions may be made to the method 500 and/or one or more operations included in the method 500 without departing from the scope of the present disclosure. For example, the operations corresponding to the method 500 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### Example Autonomous Vehicle

FIG. 6A is an illustration of an example autonomous vehicle 600, in accordance with some embodiments of the present disclosure. The autonomous vehicle 600 (alternatively referred to herein as the “vehicle 600”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 600 may be capable of functionality in accordance with one or more of Level 3-Level 5 of the autonomous driving levels. The vehicle 600 may be capable of functionality in accordance with one or more of Level 1-Level 5 of the autonomous driving levels. For example, the vehicle 600 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 600 or other machine, such as being fully autonomous, being highly autonomous, being conditionally autonomous, being partially autonomous, providing assistive autonomy, being semi-autonomous, being primarily autonomous, or other designation.

The vehicle 600 may include components such as a chassis, a vehicle body, wheels (e.g., 2, 4, 6, 8, 18, etc.), tires, axles, and other components of a vehicle. The vehicle 600 may include a propulsion system 650, such as an internal combustion engine, hybrid electric power plant, an all-electric engine, and/or another propulsion system type. The propulsion system 650 may be connected to a drive train of the vehicle 600, which may include a transmission, to enable the propulsion of the vehicle 600. The propulsion system 650 may be controlled in response to receiving signals from the throttle/accelerator 652.

A steering system 654, which may include a steering wheel, may be used to steer the vehicle 600 (e.g., along a desired path or route) when the propulsion system 650 is operating (e.g., when the vehicle is in motion). The steering system 654 may receive signals from a steering actuator 656. The steering wheel may be optional for full automation (Level 5) functionality.

The brake sensor system 646 may be used to operate the vehicle brakes in response to receiving signals from the brake actuators 648 and/or brake sensors.

Controller(s) 636, which may include one or more CPU(s), system on chips (SoCs) 604 (FIG. 6C) and/or GPU(s), may provide signals (e.g., representative of commands) to one or more components and/or systems of the vehicle 600. For example, the controller(s) may send signals to operate the vehicle brakes via one or more brake actuators 648, to operate the steering system 654 via one or more steering actuators 656, and/or to operate the propulsion system 650 via one or more throttle/accelerators 652. The controller(s) 636 may include one or more onboard (e.g., integrated) computing devices (e.g., supercomputers) that process sensor signals, and output operation commands (e.g., signals representing commands) to enable autonomous driving and/or to assist a human driver in driving the vehicle 600. The controller(s) 636 may include a first controller 636 for autonomous driving functions, a second controller 636 for functional safety functions, a third controller 636 for artificial intelligence functionality (e.g., computer vision), a fourth controller 636 for infotainment functionality, a fifth controller 636 for redundancy in emergency conditions, and/or other controllers. In some examples, a single controller 636 may handle two or more of the above functionalities, two or more controllers 636 may handle a single functionality, and/or any combination thereof.

The controller(s) 636 may provide the signals for controlling one or more components and/or systems of the vehicle 600 in response to sensor data received from one or more sensors (e.g., sensor inputs). The sensor data may be received from, for example and without limitation, global navigation satellite systems sensor(s) 658 (e.g., Global Positioning System sensor(s)), RADAR sensor(s) 660, ultrasonic sensor(s) 662, LIDAR sensor(s) 664, inertial measurement unit (IMU) sensor(s) 666 (e.g., accelerometer(s), gyroscope(s), magnetic compass(es), magnetometer(s), etc.), microphone(s) 696, stereo camera(s) 668, wide-view camera(s) 670 (e.g., fisheye cameras), infrared camera(s) 672, surround camera(s) 674 (e.g., 360 degree cameras), long-range and/or mid-range camera(s) 698, speed sensor(s) 644 (e.g., for measuring the speed of the vehicle 600), vibration sensor(s) 642, steering sensor(s) 640, brake sensor(s) 646 (e.g., as part of the brake sensor system 646), and/or other sensor types.

One or more of the controller(s) 636 may receive inputs (e.g., represented by input data) from an instrument cluster 632 of the vehicle 600 and provide outputs (e.g., represented by output data, display data, etc.) via a human-machine interface (HMI) display 634, an audible annunciator, a loudspeaker, and/or via other components of the vehicle 600. The outputs may include information such as vehicle velocity, speed, time, map data (e.g., the HD map 622 of FIG. 6C), location data (e.g., the location of the vehicle 600, such as on a map), direction, location of other vehicles (e.g., an occupancy grid), information about objects and status of objects as perceived by the controller(s) 636, etc. For example, the HMI display 634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 600 further includes a network interface 624, which may use one or more wireless antenna(s) 626 and/or modem(s) to communicate over one or more networks. For example, the network interface 624 may be capable of communication over LTE, WCDMA, UMTS, GSM, CDMA2000, etc. The wireless antenna(s) 626 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 6B is an example of camera locations and fields of view for the example autonomous vehicle 600 of FIG. 6A, in accordance with some embodiments of the present disclosure. The cameras and respective fields of view are one example embodiment and are not intended to be limiting. For example, additional and/or alternative cameras may be included and/or the cameras may be located at different locations on the vehicle 600.

The camera types for the cameras may include, but are not limited to, digital cameras that may be adapted for use with the components and/or systems of the vehicle 600. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 600 (e.g., front-facing cameras) may be used for surround view, to help identify forward-facing paths and obstacles, as well aid in, with the help of one or more controllers 636 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 670 that may be used to perceive objects coming into view from the periphery (e.g., pedestrians, crossing traffic or bicycles). Although only one wide-view camera is illustrated in FIG. 6B, there may any number of wide-view cameras 670 on the vehicle 600. In addition, long-range camera(s) 698 (e.g., a long-view stereo camera pair) may be used for depth-based object detection, especially for objects for which a neural network has not yet been trained. The long-range camera(s) 698 may also be used for object detection and classification, as well as basic object tracking.

One or more stereo cameras 668 may also be included in a front-facing configuration. The stereo camera(s) 668 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 668 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 668 may be used in addition to, or alternatively from, those described herein.

Cameras with a field of view that include portions of the environment to the side of the vehicle 600 (e.g., side-view cameras) may be used for surround view, providing information used to create and update the occupancy grid, as well as to generate side impact collision warnings. For example, surround camera(s) 674 (e.g., four surround cameras 674 as illustrated in FIG. 6B) may be positioned to on the vehicle 600. The surround camera(s) 674 may include wide-view camera(s) 670, fisheye camera(s), 360-degree camera(s), and/or the like. For example, four fisheye cameras may be positioned on the vehicle's front, rear, and sides. In an alternative arrangement, the vehicle may use three surround camera(s) 674 (e.g., left, right, and rear), and may leverage one or more other camera(s) (e.g., a forward-facing camera) as a fourth surround-view camera.

Cameras with a field of view that include portions of the environment to the rear of the vehicle 600 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 698, stereo camera(s) 668), infrared camera(s) 672, etc.), as described herein.

FIG. 6C is a block diagram of an example system architecture for the example autonomous vehicle 600 of FIG. 6A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 600 in FIG. 6C is illustrated as being connected via bus 602. The bus 602 may include a Controller Area Network (CAN) data interface (alternatively referred to herein as a “CAN bus”). A CAN may be a network inside the vehicle 600 used to aid in control of various features and functionality of the vehicle 600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 602 is described herein as being a CAN bus, this is not intended to be limiting. For example, in addition to, or alternatively from, the CAN bus, FlexRay and/or Ethernet may be used. Additionally, although a single line is used to represent the bus 602, this is not intended to be limiting. For example, there may be any number of busses 602, which may include one or more CAN busses, one or more FlexRay busses, one or more Ethernet busses, and/or one or more other types of busses using a different protocol. In some examples, two or more busses 602 may be used to perform different functions, and/or may be used for redundancy. For example, a first bus 602 may be used for collision avoidance functionality and a second bus 602 may be used for actuation control. In any example, each bus 602 may communicate with any of the components of the vehicle 600, and two or more busses 602 may communicate with the same components. In some examples, each SoC 604, each controller 636, and/or each computer within the vehicle may have access to the same input data (e.g., inputs from sensors of the vehicle 600), and may be connected to a common bus, such the CAN bus.

The vehicle 600 may include one or more controller(s) 636, such as those described herein with respect to FIG. 6A. The controller(s) 636 may be used for a variety of functions. The controller(s) 636 may be coupled to any of the various other components and systems of the vehicle 600 and may be used for control of the vehicle 600, artificial intelligence of the vehicle 600, infotainment for the vehicle 600, and/or the like.

The vehicle 600 may include a system(s) on a chip (SoC) 604. The SoC 604 may include CPU(s) 606, GPU(s) 608, processor(s) 610, cache(s) 612, accelerator(s) 614, data store(s) 616, and/or other components and features not illustrated. The SoC(s) 604 may be used to control the vehicle 600 in a variety of platforms and systems. For example, the SoC(s) 604 may be combined in a system (e.g., the system of the vehicle 600) with an HD map 622 which may obtain map refreshes and/or updates via a network interface 624 from one or more servers (e.g., server(s) 678 of FIG. 6D).

The CPU(s) 606 may include a CPU cluster or CPU complex (alternatively referred to herein as a “CCPLEX”). The CPU(s) 606 may include multiple cores and/or L2 caches. For example, in some embodiments, the CPU(s) 606 may include eight cores in a coherent multi-processor configuration. In some embodiments, the CPU(s) 606 may include four dual-core clusters where each cluster has a dedicated L2 cache (e.g., a 2 MB L2 cache). The CPU(s) 606 (e.g., the CCPLEX) may be configured to support simultaneous cluster operation enabling any combination of the clusters of the CPU(s) 606 to be active at any given time.

The CPU(s) 606 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 606 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 608 may include an integrated GPU (alternatively referred to herein as an “iGPU”). The GPU(s) 608 may be programmable and may be efficient for parallel workloads. The GPU(s) 608, in some examples, may use an enhanced tensor instruction set. The GPU(s) 608 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 608 may include at least eight streaming microprocessors. The GPU(s) 608 may use compute application programming interface(s) (API(s)). In addition, the GPU(s) 608 may use one or more parallel computing platforms and/or programming models (e.g., NVIDIA's CUDA).

The GPU(s) 608 may be power-optimized for best performance in automotive and embedded use cases. For example, the GPU(s) 608 may be fabricated on a Fin field-effect transistor (FinFET). However, this is not intended to be limiting, and the GPU(s) 608 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 608 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 608 to access the CPU(s) 606 page tables directly. In such examples, when the GPU(s) 608 memory management unit (MMU) experiences a miss, an address translation request may be transmitted to the CPU(s) 606. In response, the CPU(s) 606 may look in its page tables for the virtual-to-physical mapping for the address and transmits the translation back to the GPU(s) 608. As such, unified memory technology may allow a single unified virtual address space for memory of both the CPU(s) 606 and the GPU(s) 608, thereby simplifying the GPU(s) 608 programming and porting of applications to the GPU(s) 608.

In addition, the GPU(s) 608 may include an access counter that may keep track of the frequency of access of the GPU(s) 608 to memory of other processors. The access counter may help ensure that memory pages are moved to the physical memory of the processor that is accessing the pages most frequently.

The SoC(s) 604 may include any number of cache(s) 612, including those described herein. For example, the cache(s) 612 may include an L3 cache that is available to both the CPU(s) 606 and the GPU(s) 608 (e.g., that is connected to both the CPU(s) 606 and the GPU(s) 608). The cache(s) 612 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 604 may include an arithmetic logic unit(s) (ALU(s)) which may be leveraged in performing processing with respect to any of the variety of tasks or operations of the vehicle 600—such as processing DNNs. In addition, the SoC(s) 604 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 606 and/or GPU(s) 608.

The SoC(s) 604 may include one or more accelerators 614 (e.g., hardware accelerators, software accelerators, or a combination thereof). For example, the SoC(s) 604 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 608 and to off-load some of the tasks of the GPU(s) 608 (e.g., to free up more cycles of the GPU(s) 608 for performing other tasks). As an example, the accelerator(s) 614 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 614 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 608, and by using an inference accelerator, for example, a designer may target either the DLA(s) or the GPU(s) 608 for any function. For example, the designer may focus processing of CNNs and floating point operations on the DLA(s) and leave other functions to the GPU(s) 608 and/or other accelerator(s) 614.

The accelerator(s) 614 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 606. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 614 (e.g., the hardware acceleration cluster) may include a computer vision network on-chip and SRAM, for providing a high-bandwidth, low latency SRAM for the accelerator(s) 614. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 604 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 614 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 666 output that correlates with the vehicle 600 orientation, distance, 3D location estimates of the object obtained from the neural network and/or other sensors (e.g., LIDAR sensor(s) 664 or RADAR sensor(s) 660), among others.

The SoC(s) 604 may include data store(s) 616 (e.g., memory). The data store(s) 616 may be on-chip memory of the SoC(s) 604, which may store neural networks to be executed on the GPU and/or the DLA. In some examples, the data store(s) 616 may be large enough in capacity to store multiple instances of neural networks for redundancy and safety. The data store(s) 616 may comprise L2 or L3 cache(s) 612. Reference to the data store(s) 616 may include reference to the memory associated with the PVA, DLA, and/or other accelerator(s) 614, as described herein.

The SoC(s) 604 may include one or more processor(s) 610 (e.g., embedded processors). The processor(s) 610 may include a boot and power management processor that may be a dedicated processor and subsystem to handle boot power and management functions and related security enforcement. The boot and power management processor may be a part of the SoC(s) 604 boot sequence and may provide runtime power management services. The boot power and management processor may provide clock and voltage programming, assistance in system low power state transitions, management of SoC(s) 604 thermals and temperature sensors, and/or management of the SoC(s) 604 power states. Each temperature sensor may be implemented as a ring-oscillator whose output frequency is proportional to temperature, and the SoC(s) 604 may use the ring-oscillators to detect temperatures of the CPU(s) 606, GPU(s) 608, and/or accelerator(s) 614. If temperatures are determined to exceed a threshold, the boot and power management processor may enter a temperature fault routine and put the SoC(s) 604 into a lower power state and/or put the vehicle 600 into a chauffeur to safe-stop mode (e.g., bring the vehicle 600 to a safe stop).

The processor(s) 610 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 610 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 610 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 610 may further include a real-time camera engine that may include a dedicated processor subsystem for handling real-time camera management.

The processor(s) 610 may further include a high dynamic range signal processor that may include an image signal processor that is a hardware engine that is part of the camera processing pipeline.

The processor(s) 610 may include a video image compositor that may be a processing block (e.g., implemented on a microprocessor) that implements video post-processing functions needed by a video playback application to produce the final image for the player window. The video image compositor may perform lens distortion correction on wide-view camera(s) 670, surround camera(s) 674, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 608 is not required to continuously render new surfaces. Even when the GPU(s) 608 is powered on and active doing 3D rendering, the video image compositor may be used to offload the GPU(s) 608 to improve performance and responsiveness.

The SoC(s) 604 may further include a mobile industry processor interface (MIPI) camera serial interface for receiving video and input from cameras, a high-speed interface, and/or a video input block that may be used for camera and related pixel input functions. The SoC(s) 604 may further include an input/output controller(s) that may be controlled by software and may be used for receiving I/O signals that are uncommitted to a specific role.

The SoC(s) 604 may further include a broad range of peripheral interfaces to enable communication with peripherals, audio codecs, power management, and/or other devices. The SoC(s) 604 may be used to process data from cameras (e.g., connected over Gigabit Multimedia Serial Link and Ethernet), sensors (e.g., LIDAR sensor(s) 664, RADAR sensor(s) 660, etc. that may be connected over Ethernet), data from bus 602 (e.g., speed of vehicle 600, steering wheel position, etc.), data from GNSS sensor(s) 658 (e.g., connected over Ethernet or CAN bus). The SoC(s) 604 may further include dedicated high-performance mass storage controllers that may include their own DMA engines, and that may be used to free the CPU(s) 606 from routine data management tasks.

The SoC(s) 604 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 604 may be faster, more reliable, and even more energy-efficient and space-efficient than conventional systems. For example, the accelerator(s) 614, when combined with the CPU(s) 606, the GPU(s) 608, and the data store(s) 616, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 620) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 608.

In some examples, a CNN for facial recognition and vehicle owner identification may use data from camera sensors to identify the presence of an authorized driver and/or owner of the vehicle 600. The always-on sensor processing engine may be used to unlock the vehicle when the owner approaches the driver door and turn on the lights, and, in security mode, to disable the vehicle when the owner leaves the vehicle. In this way, the SoC(s) 604 provide for security against theft and/or carjacking.

In another example, a CNN for emergency vehicle detection and identification may use data from microphones 696 to detect and identify emergency vehicle sirens. In contrast to conventional systems, that use general classifiers to detect sirens and manually extract features, the SoC(s) 604 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 658. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 662, until the emergency vehicle(s) passes.

The vehicle may include a CPU(s) 618 (e.g., discrete CPU(s), or dCPU(s)), that may be coupled to the SoC(s) 604 via a high-speed interconnect (e.g., PCIe). The CPU(s) 618 may include an X86 processor, for example. The CPU(s) 618 may be used to perform any of a variety of functions, including arbitrating potentially inconsistent results between ADAS sensors and the SoC(s) 604, and/or monitoring the status and health of the controller(s) 636 and/or infotainment SoC 630, for example.

The vehicle 600 may include a GPU(s) 620 (e.g., discrete GPU(s), or dGPU(s)), that may be coupled to the SoC(s) 604 via a high-speed interconnect (e.g., NVIDIA's NVLINK). The GPU(s) 620 may provide additional artificial intelligence functionality, such as by executing redundant and/or different neural networks, and may be used to train and/or update neural networks based on input (e.g., sensor data) from sensors of the vehicle 600.

The vehicle 600 may further include the network interface 624 which may include one or more wireless antennas 626 (e.g., one or more wireless antennas for different communication protocols, such as a cellular antenna, a Bluetooth antenna, etc.). The network interface 624 may be used to enable wireless connectivity over the Internet with the cloud (e.g., with the server(s) 678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 600 information about vehicles in proximity to the vehicle 600 (e.g., vehicles in front of, on the side of, and/or behind the vehicle 600). This functionality may be part of a cooperative adaptive cruise control functionality of the vehicle 600.

The network interface 624 may include a SoC that provides modulation and demodulation functionality and enables the controller(s) 636 to communicate over wireless networks. The network interface 624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 600 may further include data store(s) 628, which may include off-chip (e.g., off the SoC(s) 604) storage. The data store(s) 628 may include one or more storage elements including RAM, SRAM, DRAM, VRAM, Flash, hard disks, and/or other components and/or devices that may store at least one bit of data.

The vehicle 600 may further include GNSS sensor(s) 658. The GNSS sensor(s) 658 (e.g., GPS, assisted GPS sensors, differential GPD (DGPS) sensors, etc.), to assist in mapping, perception, occupancy grid generation, and/or path planning functions. Any number of GNSS sensor(s) 658 may be used, including, for example and without limitation, a GPS using a USB connector with an Ethernet to Serial (RS-232) bridge.

The vehicle 600 may further include RADAR sensor(s) 660. The RADAR sensor(s) 660 may be used by the vehicle 600 for long-range vehicle detection, even in darkness and/or severe weather conditions. RADAR functional safety levels may be ASIL B. The RADAR sensor(s) 660 may use the CAN and/or the bus 602 (e.g., to transmit data generated by the RADAR sensor(s) 660) for control and to access object tracking data, with access to Ethernet to access raw data, in some examples. A wide variety of RADAR sensor types may be used. For example, and without limitation, the RADAR sensor(s) 660 may be suitable for front, rear, and side RADAR use. In some example, Pulse Doppler RADAR sensor(s) are used.

The RADAR sensor(s) 660 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 660 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 600 surrounding at higher speeds with minimal interference from traffic in adjacent lanes. The other two antennae may expand the field of view, making it possible to quickly detect vehicles entering or leaving the vehicle's 600 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 600 may further include ultrasonic sensor(s) 662. The ultrasonic sensor(s) 662, which may be positioned at the front, back, and/or the sides of the vehicle 600, may be used for park assist and/or to create and update an occupancy grid. A wide variety of ultrasonic sensor(s) 662 may be used, and different ultrasonic sensor(s) 662 may be used for different ranges of detection (e.g., 2.5 m, 4 m). The ultrasonic sensor(s) 662 may operate at functional safety levels of ASIL B.

The vehicle 600 may include LIDAR sensor(s) 664. The LIDAR sensor(s) 664 may be used for object and pedestrian detection, emergency braking, collision avoidance, and/or other functions. The LIDAR sensor(s) 664 may be functional safety level ASIL B. In some examples, the vehicle 600 may include multiple LIDAR sensors 664 (e.g., two, four, six, etc.) that may use Ethernet (e.g., to provide data to a Gigabit Ethernet switch).

In some examples, the LIDAR sensor(s) 664 may be capable of providing a list of objects and their distances for a 360-degree field of view. Commercially available LIDAR sensor(s) 664 may have an advertised range of approximately 100 m, with an accuracy of 2 cm-3 cm, and with support for a 100 Mbps Ethernet connection, for example. In some examples, one or more non-protruding LIDAR sensors 664 may be used. In such examples, the LIDAR sensor(s) 664 may be implemented as a small device that may be embedded into the front, rear, sides, and/or corners of the vehicle 600. The LIDAR sensor(s) 664, in such examples, may provide up to a 120-degree horizontal and 35-degree vertical field-of-view, with a 200 m range even for low-reflectivity objects. Front-mounted LIDAR sensor(s) 664 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 600. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 664 may be less susceptible to motion blur, vibration, and/or shock.

The vehicle may further include IMU sensor(s) 666. The IMU sensor(s) 666 may be located at a center of the rear axle of the vehicle 600, in some examples. The IMU sensor(s) 666 may include, for example and without limitation, an accelerometer(s), a magnetometer(s), a gyroscope(s), a magnetic compass(es), and/or other sensor types. In some examples, such as in six-axis applications, the IMU sensor(s) 666 may include accelerometers and gyroscopes, while in nine-axis applications, the IMU sensor(s) 666 may include accelerometers, gyroscopes, and magnetometers.

In some embodiments, the IMU sensor(s) 666 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 666 may enable the vehicle 600 to estimate heading without requiring input from a magnetic sensor by directly observing and correlating the changes in velocity from GPS to the IMU sensor(s) 666. In some examples, the IMU sensor(s) 666 and the GNSS sensor(s) 658 may be combined in a single integrated unit.

The vehicle may include microphone(s) 696 placed in and/or around the vehicle 600. The microphone(s) 696 may be used for emergency vehicle detection and identification, among other things.

The vehicle may further include any number of camera types, including stereo camera(s) 668, wide-view camera(s) 670, infrared camera(s) 672, surround camera(s) 674, long-range and/or mid-range camera(s) 698, and/or other camera types. The cameras may be used to capture image data around an entire periphery of the vehicle 600. The types of cameras used depends on the embodiments and requirements for the vehicle 600, and any combination of camera types may be used to provide the necessary coverage around the vehicle 600. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 6A and FIG. 6B.

The vehicle 600 may further include vibration sensor(s) 642. The vibration sensor(s) 642 may measure vibrations of components of the vehicle, such as the axle(s). For example, changes in vibrations may indicate a change in road surfaces. In another example, when two or more vibration sensors 642 are used, the differences between the vibrations may be used to determine friction or slippage of the road surface (e.g., when the difference in vibration is between a power-driven axle and a freely rotating axle).

The vehicle 600 may include an ADAS system 638. The ADAS system 638 may include a SoC, in some examples. The ADAS system 638 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 660, LIDAR sensor(s) 664, and/or a camera(s). The ACC systems may include longitudinal ACC and/or lateral ACC. Longitudinal ACC monitors and controls the distance to the vehicle immediately ahead of the vehicle 600 and automatically adjust the vehicle speed to maintain a safe distance from vehicles ahead. Lateral ACC performs distance keeping, and advises the vehicle 600 to change lanes when necessary. Lateral ACC is related to other ADAS applications such as LCA and CWS.

CACC uses information from other vehicles that may be received via the network interface 624 and/or the wireless antenna(s) 626 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 600), while the I2V communication concept provides information about traffic further ahead. CACC systems may include either or both I2V and V2V information sources. Given the information of the vehicles ahead of the vehicle 600, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 660, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 660, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 600 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 600 if the vehicle 600 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 600 is backing up. Some RCTW systems include AEB to ensure that the vehicle brakes are applied to avoid a crash. RCTW systems may use one or more rear-facing RADAR sensor(s) 660, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 600, the vehicle 600 itself must, in the case of conflicting results, decide whether to heed the result from a primary computer or a secondary computer (e.g., a first controller 636 or a second controller 636). For example, in some embodiments, the ADAS system 638 may be a backup and/or secondary computer for providing perception information to a backup computer rationality module. The backup computer rationality monitor may run a redundant diverse software on hardware components to detect faults in perception and dynamic driving tasks. Outputs from the ADAS system 638 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 604.

In other examples, ADAS system 638 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 638 may be fed into the primary computer's perception block and/or the primary computer's dynamic driving task block. For example, if the ADAS system 638 indicates a forward crash warning due to an object immediately ahead, the perception block may use this information when identifying objects. In other examples, the secondary computer may have its own neural network that is trained and thus reduces the risk of false positives, as described herein.

The vehicle 600 may further include the infotainment SoC 630 (e.g., an in-vehicle infotainment system (IVI)). Although illustrated and described as an SoC, the infotainment system may not be a SoC, and may include two or more discrete components. The infotainment SoC 630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 600. For example, the infotainment SoC 630 may include radios, disk players, navigation systems, video players, USB and Bluetooth connectivity, carputers, in-car entertainment, Wi-Fi, steering wheel audio controls, hands-free voice control, a heads-up display (HUD), an HMI display 634, a telematics device, a control panel (e.g., for controlling and/or interacting with various components, features, and/or systems), and/or other components. The infotainment SoC 630 may further be used to provide information (e.g., visual and/or audible) to a user(s) of the vehicle, such as information from the ADAS system 638, autonomous driving information such as planned vehicle maneuvers, trajectories, surrounding environment information (e.g., intersection information, vehicle information, road information, etc.), and/or other information.

The infotainment SoC 630 may include GPU functionality. The infotainment SoC 630 may communicate over the bus 602 (e.g., CAN bus, Ethernet, etc.) with other devices, systems, and/or components of the vehicle 600. In some examples, the infotainment SoC 630 may be coupled to a supervisory MCU such that the GPU of the infotainment system may perform some self-driving functions in the event that the primary controller(s) 636 (e.g., the primary and/or backup computers of the vehicle 600) fail. In such an example, the infotainment SoC 630 may put the vehicle 600 into a chauffeur to safe-stop mode, as described herein.

The vehicle 600 may further include an instrument cluster 632 (e.g., a digital dash, an electronic instrument cluster, a digital instrument panel, etc.). The instrument cluster 632 may include a controller and/or supercomputer (e.g., a discrete controller or supercomputer). The instrument cluster 632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 630 and the instrument cluster 632. In other words, the instrument cluster 632 may be included as part of the infotainment SoC 630, or vice versa.

FIG. 6D is a system diagram for communication between cloud-based server(s) and the example autonomous vehicle 600 of FIG. 6A, in accordance with some embodiments of the present disclosure. The system 676 may include server(s) 678, network(s) 690, and vehicles, including the vehicle 600. The server(s) 678 may include a plurality of GPUs 684(A)-684(H) (collectively referred to herein as GPUs 684), PCIe switches 682(A)-682(H) (collectively referred to herein as PCIe switches 682), and/or CPUs 680(A)-680(B) (collectively referred to herein as CPUs 680). The GPUs 684, the CPUs 680, and the PCIe switches may be interconnected with high-speed interconnects such as, for example and without limitation, NVLink interfaces 688 developed by NVIDIA and/or PCIe connections 686. In some examples, the GPUs 684 are connected via NVLink and/or NVSwitch SoC and the GPUs 684 and the PCIe switches 682 are connected via PCIe interconnects. Although eight GPUs 684, two CPUs 680, and two PCIe switches are illustrated, this is not intended to be limiting. Depending on the embodiment, each of the server(s) 678 may include any number of GPUs 684, CPUs 680, and/or PCIe switches. For example, the server(s) 678 may each include eight, sixteen, thirty-two, and/or more GPUs 684.

The server(s) 678 may receive, over the network(s) 690 and from the vehicles, image data representative of images showing unexpected or changed road conditions, such as recently commenced road work. The server(s) 678 may transmit, over the network(s) 690 and to the vehicles, neural networks 692, updated neural networks 692, and/or map information 694, including information regarding traffic and road conditions. The updates to the map information 694 may include updates for the HD map 622, such as information regarding construction sites, potholes, detours, flooding, and/or other obstructions. In some examples, the neural networks 692, the updated neural networks 692, and/or the map information 694 may have resulted from new training and/or experiences represented in data received from any number of vehicles in the environment, and/or based on training performed at a datacenter (e.g., using the server(s) 678 and/or other servers).

The server(s) 678 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 690, and/or the machine learning models may be used by the server(s) 678 to remotely monitor the vehicles.

In some examples, the server(s) 678 may receive data from the vehicles and apply the data to up-to-date real-time neural networks for real-time intelligent inferencing. The server(s) 678 may include deep-learning supercomputers and/or dedicated AI computers powered by GPU(s) 684, such as a DGX and DGX Station machines developed by NVIDIA. However, in some examples, the server(s) 678 may include deep learning infrastructure that use only CPU-powered datacenters.

The deep-learning infrastructure of the server(s) 678 may be capable of fast, real-time inferencing, and may use that capability to evaluate and verify the health of the processors, software, and/or associated hardware in the vehicle 600. For example, the deep-learning infrastructure may receive periodic updates from the vehicle 600, such as a sequence of images and/or objects that the vehicle 600 has located in that sequence of images (e.g., via computer vision and/or other machine learning object classification techniques). The deep-learning infrastructure may run its own neural network to identify the objects and compare them with the objects identified by the vehicle 600 and, if the results do not match and the infrastructure concludes that the AI in the vehicle 600 is malfunctioning, the server(s) 678 may transmit a signal to the vehicle 600 instructing a fail-safe computer of the vehicle 600 to assume control, notify the passengers, and complete a safe parking maneuver.

For inferencing, the server(s) 678 may include the GPU(s) 684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point, connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that enable the computing device 700 to communicate with other computing devices via an electronic communication network, include wired and/or wireless communications. The communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may enable the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 700. The computing device 700 may include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that enable detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to enable the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, etc.), and output the data (e.g., as an image, video, sound, etc.).

### Example Data Center

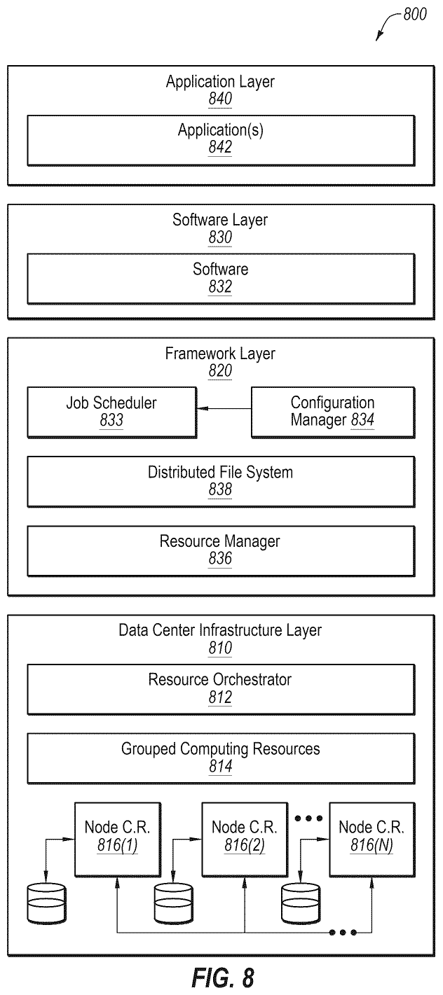

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-816(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 832, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 800. In at least one embodiment, trained or deployed machine learning models corresponding to one or more neural networks may be used to infer or predict information using resources described in the present disclosure with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Example 1. A method may include:
obtaining first data including one or more performance indicator values corresponding to performance of the system;
obtaining second data including one or more operational domain parameters corresponding to a system;
assembling a data structure based at least on the first data and the second data, the assembling of the data structure including aligning, according to time the first data and the second data;
determining one or more respective correlations between one or more individual operational domain parameters of the one or more operational domain parameters and one or more individual performance indicator values of the one or more performance indicator values based on the assembled data structure; and
modifying one or more aspects of the system based at least on the one or more respective correlations.

The method included in Example 1, wherein the second data is obtained from a plurality of sources and is preprocessed to improve uniformity between the data obtained from the plurality of sources.

The method included in Example 1, wherein the aligning of the first data and of the second data includes associating first data subsets and second data subsets that correspond to same time frames.

The method included in Example 1, the first data includes a first plurality of timestamps respectively corresponding to the one or more performance indicator values;
the second data includes a second plurality of timestamps respectively corresponding to the one or more operational domain parameters; and
the aligning of the first data and the second data is based at least on the first plurality of timestamps and the second plurality of timestamps.

The method included in Example 1, wherein the determining of the one or more correlations is based at least on distributions between performance indicator values and operational domain parameters that are time aligned in the data structure.

The method included in Example 1, further comprising identifying that a first operational domain parameter affects a particular performance indicator more than a second operational domain parameter based at least on the one or more respective correlations.

The method included in Example 1, wherein the determining of the one or more correlations includes determining at least one degree of confidence for at least one of the one or more correlations.

Example 2. A system may include:
one or more processors comprising processing circuitry to perform operations comprising:
assembling a data structure based at least on first data and second data, the first data including one or more performance indicator values corresponding to performance of the system and the second data including one or more operational domain parameters corresponding to the system;
determining one or more respective correlations between one or more individual operational domain parameters of the one or more operational domain parameters and one or more individual performance indicator values of the one or more performance indicator values based on the first data and the second data; and
modifying one or more aspects of the system based at least on the one or more respective correlations.

The system included in Example 2, where the operations may further include:
determining a causal connection between at least one of the one or more individual operational domain parameters and at least one of the one or more performance indicator values based at least on the first data and the second data.

The system included in Example 2, wherein the second data is obtained from a plurality of sources and it preprocessed to improve uniformity between the data obtained from the plurality of sources.

The system included in Example 2, wherein:
the first data includes a first plurality of timestamps respectively corresponding to the one or more performance indicator values;
the second data includes a second plurality of timestamps respectively corresponding to the one or more operational domain parameters; and
the aligning of the first data and the second data is based at least on the first plurality of timestamps and the second plurality of timestamps.

The system included in Example 2, wherein the determining of the one or more correlations is based at least on distributions between performance indicator values and operational domain parameters that are time aligned in the data structure.

The system included in Example 2, the operations further comprising identifying that a first operational domain parameter affects a particular performance indicator more than a second operational domain parameter based at least on the one or more respective correlations.

The system included in Example 2, wherein the determining of the one or more correlations includes determining at least one degree of confidence for at least one of the one or more correlations.

The system included in Example 2, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

Example 3. A processor comprising processing circuitry to perform operations comprising:
obtaining first data including one or more performance indicator values corresponding to performance of the system;
obtaining second data including one or more operational domain parameters corresponding to a system;
assembling a data structure based at least on the first data and the second data, the assembling of the data structure including aligning, according to time the first data and the second data;
determining one or more respective correlations between one or more individual operational domain parameters of the one or more operational domain parameters and one or more individual performance indicator values of the one or more performance indicator values based on the assembled data structure; and
modifying one or more aspects of the system based at least on the one or more respective correlations.

The processor included in Example 3, wherein:
the first data includes a first plurality of timestamps respectively corresponding to the one or more performance indicator values;
the second data includes a second plurality of timestamps respectively corresponding to the one or more operational domain parameters; and
the aligning of the first data and the second data is based at least on the first plurality of timestamps and the second plurality of timestamps.

The processor included in Example 3, wherein the determining of the one or more correlations is based at least on distributions between performance indicator values and operational domain parameters that are time aligned in the data structure.

The processor included in Example 3, the operations further comprising identifying that a first operational domain parameter affects a particular performance indicator more than a second operational domain parameter based at least on the one or more respective correlations.

The processor included in Example 3, where the processor is included in a system, the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

1. A method comprising:
obtaining first data including one or more performance indicator values corresponding to performance of a system included in an autonomous or semi-autonomous machine;
obtaining second data including one or more values of one or more operational domain parameters corresponding to the system;
assembling a data structure based at least on the first data and the second data, the assembling of the data structure including aligning, based at least on time, the first data and the second data;
determining one or more respective correlations between at least one value of at least one operational domain parameter of the one or more operational domain parameters and at least one performance indicator value of the one or more performance indicator values based at least on the assembled data structure; and
modifying one or more planning, navigation, or control operations of the system based at least on the one or more respective correlations.

2. The method of claim 1, wherein the second data is obtained from a plurality of sources and is preprocessed to improve uniformity between the second data obtained from the plurality of sources.

3. The method of claim 1, wherein the aligning of the first data and of the second data includes associating first data subsets and second data subsets that correspond to same time frames.

4. The method of claim 1, wherein:
the first data includes a first plurality of timestamps respectively corresponding to the one or more performance indicator values;
the second data includes a second plurality of timestamps respectively corresponding to the one or more operational domain parameters; and
the aligning of the first data and the second data is based at least on the first plurality of timestamps and the second plurality of timestamps.

5. The method of claim 1, wherein the determining of the one or more respective correlations is based at least on distributions between performance indicator values and values of the operational domain parameters that are time aligned in the data structure.

6. The method of claim 1, further comprising identifying that a first operational domain parameter affects a particular performance indicator more than a second operational domain parameter based at least on the one or more respective correlations.

7. The method of claim 1, wherein the determining of the one or more respective correlations includes determining at least one degree of confidence for at least one of the one or more respective correlations.

8. A system comprising:
one or more processors comprising processing circuitry to perform operations comprising:
assembling a data structure based at least on first data and second data, the first data including one or more performance indicator values corresponding to performance of the system and the second data including one or more values of one or more operational domain parameters corresponding to the system, the system included in an autonomous or semi-autonomous machine;
determining one or more respective correlations between one or more individual values of the one or more operational domain parameters and one or more individual performance indicator values of the one or more performance indicator values based at least on the first data and the second data; and
modifying one or more planning, navigation, or control operations of the system based at least on the one or more respective correlations.

9. The system of claim 8, the operations further comprising:
determining a causal connection between at least one score of the one or more scores of the operational domain parameters and at least one of the one or more performance indicator values based at least on the first data and the second data.

10. The system of claim 8, wherein the second data is obtained from a plurality of sources and is preprocessed to improve uniformity between the second data obtained from the plurality of sources.

11. The system of claim 8, wherein:
the first data includes a first plurality of timestamps respectively corresponding to the one or more performance indicator values; and
the second data includes a second plurality of timestamps respectively corresponding to the one or more operational domain parameters.

12. The system of claim 11, the operations further comprising, prior to determining the one or more respective correlations, time aligning the first data and the second data based at least on the first plurality of timestamps and the second plurality of timestamps.

13. The system of claim 8, wherein the determining of the one or more respective correlations is based at least on distributions between performance indicator values and operational domain parameters that are time aligned in the data structure.

14. The system of claim 8, wherein the determining of the one or more respective correlations includes determining at least one degree of confidence for at least one of the one or more respective correlations.

15. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more visual language models (VLMs);
a system for generating synthetic data;
a system incorporating one or more virtual machines (VMs);
a system implemented at least partially in a data center; or
a system implemented at least partially using cloud computing resources.

16. A processor comprising processing circuitry to perform operations comprising:
obtaining first data including one or more performance indicator values corresponding to performance of a system included in an autonomous or semi-autonomous machine;
obtaining second data including one or more operational domain parameter values corresponding to a system;
assembling a data structure based at least on the first data and the second data, the assembling of the data structure including aligning, based at least on time, the first data and the second data;
determining one or more respective correlations between one or more individual operational domain parameter values and one or more individual performance indicator values based at least on the assembled data structure; and
modifying one or more planning, navigation, or control operations of the system based at least on the one or more respective correlations.

17. The processor of claim 16, wherein:
the first data includes a first plurality of timestamps respectively corresponding to the one or more performance indicator values;
the second data includes a second plurality of timestamps respectively corresponding to the one or more operational domain parameter values; and
the aligning of the first data and the second data is based at least on the first plurality of timestamps and the second plurality of timestamps.

18. The processor of claim 16, wherein the determining of the one or more respective correlations is based at least on distributions between performance indicator values and operational domain parameter values that are time aligned in the data structure.

19. The processor of claim 16, the operations further comprising identifying that a first operational domain parameter value affects a particular performance indicator more than a second operational domain parameter value based at least on the one or more respective correlations.

20. The processor of claim 16 included in a system, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more visual language models (VLMs);
a system for generating synthetic data;
a system incorporating one or more virtual machines (VMs);
a system implemented at least partially in a data center; or
a system implemented at least partially using cloud computing resources.
